(19) United States
(12) Patent Application Publication
(10) Pub. No.: US 2021/0144715 A1
(43) Pub. Date: May 13, 2021

(54) TERMINAL APPARATUS

(71) Applicants: SHARP KABUSHIKI KAISHA, Sakai City, Osaka (JP); FG Innovation Company Limited, Tuen Mun, New Territories (HK)

(72) Inventors: JUNGO GOTOH, Sakai City, Osaka (JP); OSAMU NAKAMURA, Sakai City, Osaka (JP); SEIJI SATO, Sakai City, Osaka (JP); YASUHIRO HAMAGUCHI, Sakai City, Osaka (JP)

(21) Appl. No.: 17/044,720

(22) PCT Filed: Apr. 4, 2019
(86) PCT No.: PCT/JP2019/014924

§ 371 Date: Oct. 1, 2020

(30) Foreign Application Priority Data
Apr. 5, 2018 (JP) 2018-073227

(51) Int. Cl. H04W 72/04; H04W 72/14; H04W 72/10; H04L 1/00; H04W 52/36; H04W 76/27

(52) U.S. Cl. CPC H04W 72/0493; H04W 72/14; H04W 72/042; H04W 76/27; H04W 72/10; H04L 1/0004; H04W 52/367; H04W 72/0413

(57) ABSTRACT

To provide a base station apparatus, a terminal apparatus, and a communication method that enable to secure high reliability and low latency of URLLC. An apparatus includes a receiver configured to detect a DCI format, and a transmitter configured to perform first data transmission based on a first DCI format and second data transmission based on a second DCI format. The receiver detects the first DCI format for the first data transmission in a first CC, and detects the second DCI format for the second data transmission in a second CC. In a case that the first data transmission and the second data transmission overlap in a time domain, and a sum of transmit power of the first data transmission and transmit power the second data transmission exceeds maximum transmit power, the transmitter allocates the transmit power to the first data transmission not to exceed the maximum transmit power. Remaining transmit power being a difference between the maximum transmit power and the transmit power of the first data transmission is allocated as the transmit power of the second data transmission.

### TECHNICAL FIELD

The present invention relates to a terminal apparatus. This application claims priority based on JP 2018-073227 filed on Apr. 5, 2018, the contents of which are incorporated herein by reference.

### BACKGROUND ART

In recent years, 5th Generation (5G) mobile telecommunication systems have been focused on, and a communication technology is expected to be specified, the technique establishing MTC mainly based on a large number of terminal apparatuses (Massive Machine Type Communications; mMTC), Ultra-reliable and low latency communications (URLLC), and enhanced Mobile BroadBand (eMBB). The 3rd Generation Partnership Project (3GPP) has been studying New Radio (NR) as a 5G communication technique and discussing NR Multiple Access (MA).

In 5G, Internet of Things (IoT) is expected to be established that allows connection of various types of equipment not previously connected to a network, and establishment of mMTC is an important issue. In 3GPP, a Machine-to-Machine (M2M) communication technology has already been standardized as Machine Type Communication (MTC) that accommodates terminal apparatuses transmitting and/or receiving small size data (NPL 1). Furthermore, in order to support data transmission at a low rate in a narrow band, standardization of Narrow Band-IoT (NB-IoT) has been conducted (NPL 2). 5G is expected to accommodate more terminals than the above-described standards and to accommodate IoT equipment requiring ultra-reliable and low-latency communications.

On the other hand, in communication systems such as Long Term Evolution (LTE) and LTE-Advanced (LTE-A) which are specified by the 3GPP, terminal apparatuses (User Equipment (UE)) use a Random Access Procedure, a Scheduling Request (SR), and the like, to request a radio resource for transmitting uplink data to a base station apparatus (also referred to as a Base Station (BS) or an evolved Node B (eNB)). The base station apparatus provides uplink grant (UL Grant) to each terminal apparatus based on an SR. In a case that the terminal apparatus receives UL Grant for control information from the base station apparatus, the terminal apparatus transmits uplink data using a prescribed radio resource (referred to as Scheduled access, grant-based access, or transmission by means of dynamic scheduling, and hereinafter referred to as scheduled access), based on an uplink transmission parameter included in the UL Grant. In this manner, the base station apparatus controls all uplink data transmissions (the base station apparatus knows radio resources for uplink data transmitted by each terminal apparatus). In the scheduled access, the base station apparatus can establish Orthogonal Multiple Access (OMA) by controlling uplink radio resources.

5G mMTC includes a problem in that the use of the scheduled access increases the amount of control information. URLLC includes a problem in that the use of the scheduled access increases delay. Thus, utilization of grant free access (also referred to as grant less access, Contention-based access, Autonomous access, Resource allocation for uplink transmission without grant, type 1 configured grant transmission, or the like, hereinafter referred to as grant free access) in which a terminal apparatus performs data transmission without a random access procedure or SR transmission, UL Grant reception, or the like and Semi-persistent scheduling (also referred to as SPS, Type 2 configured grant transmission, or the like) has been under study (NPL 3). In the grant free access, increased overhead associated with control information can be suppressed even in a case that a large number of devices transmit small size data. Furthermore, in the grant free access, no UL Grant reception or the like is performed, and thus the time from generation until transmission of transmission data can be shortened. In SPS, some transmission parameters are notified using higher layer control information, and notification is performed by using a UL Grant of activation indicating periodic usage allowance of resources together with transmission parameters not notified using a higher layer, thereby enabling data transmission.

On the other hand, in the downlink, resources allocated for data transmission of eMBB can be used for data transmission of URLLC. The base station apparatus notifies the UE being a destination of downlink eMBB of Pre-emption control information, and uses resources on which Pre-emption is performed for data transmission of downlink URLLC. Meanwhile, the terminal apparatus that has detected the Pre-emption control information for the resource scheduled for downlink data reception determines that the resource specified in the Pre-emption does not include downlink data addressed to the terminal apparatus. In the uplink as well, multiplexing of data of eMBB and URLLC between different terminal apparatuses has been under study. Further, multiplexing of data of eMBB and URLLC has also been under study in a case that one terminal apparatus includes traffic of eMBB and URLLC.

### CITATION LIST

### Non Patent Literature

NPL 1: 3GPP, TR36.888 V12.0.0, “Study on provision of low-cost Machine-Type Communications (MTC) User Equipments (UEs) based on LTE,” June 2013
NPL 2: 3GPP, TR45.820 V13.0.0, “Cellular system support for ultra-low complexity and low throughput Internet of Things (CIoT),” August 2015
NPL 3: 3GPP, TS38.214 V2.0.0, “Physical layer procedures for data (Release 15),” December 2017

### SUMMARY OF INVENTION

### Technical Problem

It is assumed that the grant free access or the SPS is used for the data transmission of URLLC, and it is assumed that the scheduled access is used for the data transmission of eMBB. In carrier aggregation, in a case that uplink grants of the dynamic scheduling or the SPS/grant free access overlap in the time domain in multiple component carriers (overlap in at least some of the OFDM symbols), transmit power is allocated for the data transmission of the multiple component carriers. However, in a case that total transmit power exceeds the maximum transmit power of the terminal apparatus for the data transmission of the multiple component carriers, the transmit power is uniformly reduced, and the transmit power is reduced at a certain ratio for the data transmission of URLLC that requires low latency and the data transmission of eMBB with relatively looser requirements of delay time, which has been presenting a problem.

One aspect of the present invention is made in the light of the circumstances as described above, and has an object to provide a base station apparatus, a terminal apparatus, and a communication method that enable implementation of data transmission based on priority of data transmission according to requirements of delay time.

### Solution to Problem

To address the above-mentioned problems, a base station apparatus, a terminal apparatus, and a communication method according to the present invention are configured as follows.

(1) One aspect of the present invention is a terminal apparatus for communicating with a base station apparatus by using multiple component carriers, the terminal apparatus including: a receiver configured to detect a first DCI format and a second DCI format; and a transmitter configured to be capable of first data transmission in which data is transmitted by using allocation information of a radio resource included in the first DCI format and second data transmission in which data is transmitted by using allocation information of a radio resource included in the second DCI format, wherein a number of bits of a field of an MCS included in the first DCI format is smaller than a number of bits of a field of an MCS included in the second DCI format, the receiver detects the first DCI format for the first data transmission in a first component carrier, and detects the second DCI format for the second data transmission in a second component carrier, in a case that the first data transmission and the second data transmission overlap in a time domain, the transmitter allocates transmit power of the first data transmission and the second data transmission such that a sum of the transmit power of the first data transmission and the second data transmission does not exceed maximum transmit power, and the transmit power of the second data transmission is configured not to exceed a value obtained by subtracting the first data transmission from the maximum transmit power.

(2) In one aspect of the present invention, the receiver detects RRC information including information of a period of the radio resource, in the first data transmission, data is able to be transmitted after activation of the period of the radio resource included in the RRC information and a periodic radio resource using the first DCI format, and in the second data transmission, data is able to be transmitted due to allocation of an aperiodic radio resource included in a DCI format.

(3) In one aspect of the present invention, the receiver detects RRC information including information of a threshold of the transmit power of the second data transmission, and in a case that the first data transmission and the second data transmission overlap in the time domain, and the sum of the transmit power of the first data transmission and the second data transmission exceeds the maximum transmit power, the transmitter allocates the transmit power to the first data transmission within a range of not exceeding the maximum transmit power, and only in a case that a difference between the maximum transmit power and the transmit power of the first data transmission exceeds the threshold of the transmit power, the transmitter performs the second data transmission.

(4) In one aspect of the present invention, the first component carrier is a secondary cell, and the second component carrier is a primary cell or a primary secondary cell, or belongs to an MCG.

(5) In one aspect of the present invention, the transmitter is capable of transmission of uplink control information. In a case that data transmission using the allocation information of the radio resource included in the first DCI format in the first component carrier and the transmission of the uplink control information in the second component carrier overlap in the time domain, the data transmission is prioritized in a case that the uplink control information is any one or both of an SR and CSI, and the data transmission and the uplink control information are transmitted in a case that an ACK/NACK is included in the uplink control information and simultaneous transmission of uplink data and the uplink control information is possible.

### Advantageous Effects of Invention

According to one or multiple aspects of the present invention, data transmission with high reliability can be implemented.

### BRIEF DESCRIPTION OF DRAWINGS

FIG. 1 is a diagram illustrating an example of a communication system according to a first embodiment.

FIG. 2 is a diagram illustrating an example of a radio frame structure for the communication system according to the first embodiment.

FIG. 3 is a schematic block diagram illustrating a configuration of a base station apparatus 10 according to the first embodiment.

FIG. 4 is a diagram illustrating an example of a signal detection unit according to the first embodiment.

FIG. 5 is a schematic block diagram illustrating a configuration of a terminal apparatus 20 according to the first embodiment.

FIG. 6 is a diagram illustrating an example of a signal detection unit according to the first embodiment.

FIG. 7 is a diagram illustrating an example of notification of an uplink grant according to related art.

FIG. 8 is a diagram illustrating an example of notification of an uplink grant according to the first embodiment.

### DESCRIPTION OF EMBODIMENTS

A communication system according to the present embodiments includes a base station apparatus (also referred to as a cell, a small cell, a pico cell, a serving cell, a component carrier, an eNodeB (eNB), a Home eNodeB, a Low Power Node; a Remote Radio Head, a gNodeB (gNB), a control station, a Bandwidth Part (BWP), or a Supplementary Uplink (SUL)), and a terminal apparatus (also referred to as a terminal, a mobile terminal, a mobile station, or User Equipment (UE)). In the communication system, in case of a downlink, the base station apparatus serves as a transmitting apparatus (a transmission point, a transmit antenna group, or a transmit antenna port group), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D) communication. In this case, the terminal apparatus serves both as a transmitting apparatus and as a receiving apparatus.

The communication system is not limited to data communication between the terminal apparatus and the base station apparatus, the communication involving human beings, but is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme such as Discrete Fourier Transform Spread-Orthogonal Frequency Division Multiplexing (DFTS-OFDM, also referred to as Single Carrier-Frequency Division Multiple Access (SC-FDMA)), Cyclic Prefix-Orthogonal Frequency Division Multiplexing and (CP-OFDM). The communication system can also use Filter Bank Multi Carrier (FBMC), Filtered-OFDM (f-OFDM) to which a filter is applied, Universal Filtered-OFDM (UF-OFDM), or Windowing-OFDM (W-OFDM), a transmission scheme using a sparse code (Sparse Code Multiple Access (SCMA)), or the like. Furthermore, the communication system may apply DFT precoding and use a signal waveform for which the filter described above is used. Furthermore, the communication system may apply code spreading, interleaving, the sparse code, and the like in the above-described transmission scheme. Note that, in the description below, at least one of the DFTS-OFDM transmission and the CP-OFDM transmission is used in the uplink, whereas the CP-OFDM transmission is used in the downlink but that the present embodiments are not limited to this configuration and any other transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval (license) from the government of the country or region is required, that is, a so-called unlicensed band. In the unlicensed band, communication may be based on carrier sense (e.g., a listen before talk scheme).

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

### First Embodiment

FIG. 1 is a diagram illustrating an example of a configuration of a communication system according to the present embodiment. The communication system according to the present embodiment includes a base station apparatus 10 and terminal apparatuses 20-1 to 20-n1 (n1 is a number of terminal apparatuses connected to the base station apparatus 10). The terminal apparatuses 20-1 and 20-n1 are also collectively referred to as terminal apparatuses 20. Coverage 10a is a range (a communication area) in which the base station apparatus 10 can connect to the terminal apparatus 20 (coverage 10a is also referred to as a cell).

In FIG. 1, radio communication of an uplink r30 at least includes the following uplink physical channels. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is a physical channel that is used to transmit Uplink Control Information (UCI). The uplink control information includes a positive acknowledgement (ACK)/Negative acknowledgement (NACK) in response to downlink data (a Downlink transport block, a Medium Access Control Protocol Data Unit (MAC PDU), a Downlink-Shared Channel (DL-SCH), and a Physical Downlink Shared Channel (PDSCH). The ACK/NACK is also referred to as a Hybrid Automatic Repeat request ACKnowledgement (HARQ-ACK), a HARQ feedback, a HARQ response, or a signal indicating HARQ control information or a delivery confirmation.

The uplink control information includes a Scheduling Request (SR) used to request a PUSCH (Uplink-Shared Channel (UL-SCH)) resource for initial transmission. The scheduling request includes a positive scheduling request or a negative scheduling request. The positive scheduling request indicates that a UL-SCH resource for initial transmission is requested. The negative scheduling request indicates that the UL-SCH resource for the initial transmission is not requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) designating a preferable transmission rate, and the like. The PMI indicates a codebook determined by the terminal apparatus. The codebook is related to precoding of the physical downlink shared channel. The CQI can use an index (CQI index) indicative of a preferable modulation scheme (for example, QPSK, 16 QAM, 64 QAM, 256 QAM, or the like), a preferable coding rate, and a preferable frequency utilization efficiency in a prescribed band. The terminal apparatus selects, from a CQI table, a CQI index considered to allow a transport block on the PDSCH to be received within a prescribed block error probability (for example, an error rate of 0.1). Here, the terminal apparatus may have multiple prescribed error probabilities (error rates) for the transport block. For example, the target of the error rate of the data of eMBB may be 0.1, and the target of the error rate of URLLC may be 0.00001. The terminal apparatus may perform CSI feedback of each target error rate (transport block error rate) in a case of being configured by using a higher layer (for example, set up by using RRC signaling from the base station), or may perform CSI feedback of a configured target error rate in a case that, by using a higher layer, one of multiple target error rates is configured by using a higher layer. Note that CSI may be calculated by using the error rate that is not the error rate for eMBB (for example, 0.1), based on whether or not a CQI table other than a CQI table for eMBB (that is, for transmission with BLER not exceeding 0.1) is selected, regardless of whether or not the error rate is configured by using RRC signaling.

Regarding the PUCCH, PUCCH formats 0 to 4 are defined. PUCCH formats 0 and 2 are transmitted using 1 to 2 OFDM symbols, and PUCCH formats 1, 3, and 4 are transmitted using 4 to 14 OFDM symbols. PUCCH formats 0 and 1 are used for notification of up to 2 bits, and can be used for notification of only the HARQ-ACK or for simultaneous notification of the HARQ-ACK and the SR. PUCCH formats 1, 3, and 4 are used for notification of more than 2 bits, and can be used for simultaneous notification of the ARQ-ACK, the SR, and the CSI. The number of OFDM symbols used for transmission of the PUCCH is configured by using a higher layer (for example, set up by using RRC signaling), and which PUCCH format is used is determined based on whether or not there is SR transmission or CSI transmission at timing (slot, OFDM symbol) that the PUCCH is transmitted.

The PUSCH is a physical channel that is used to transmit uplink data (Uplink Transport Block, Uplink-Shared Channel (UL-SCH)). The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit radio resource control (Radio Resource Control (RRC)) signaling. The RRC signaling is also referred to as an RRC message/RRC layer information/an RRC layer signal/an RRC layer parameter/RRC information/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment-specific (UE-specific) information is transmitted by using signaling that is dedicated to a certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a Power Headroom (PH) may be included in the MAC CE and may be reported via the physical uplink shared channel. In other words, a MAC CE field is used to indicate a level of the power headroom. The uplink data can include the RRC message and the MAC CE. The RRC signaling and/or the MAC CE is also referred to as a higher layer signal (higher layer signaling). The RRC signaling and/or the MAC CE are included in a transport block.

The PUSCH may be used for data transmission of dynamic scheduling (aperiodic radio resource allocation) in which uplink data transmission is performed by using a specified radio resource, based on uplink transmission parameters (for example, resource allocation in the time domain, resource allocation in the frequency domain, or the like) included in the DCI format. The PUSCH may be used for Semi-Persistent scheduling (SPS) Type 2 (Configured uplink grant (uplink grant being configured) type 2) in which data transmission using periodic radio resource is allowed, by receiving TransformPrecoder (precoder), nrofHARQ (number of HARQ processes), repK-RV (pattern of a redundancy version used in a case that the same data is repeatedly transmitted) by using RRC, then receiving DCI format 0_0/0_1 whose CRC is scrambled with a CS-RNTI, and further receiving control information of activation in which Validation is configured in a prescribed field of the received DCI format 0_0/0_1. Here, regarding the field used for Validation, the most significant bit of the MCS, an NDI, a process number of the HARQ, or the like may be used. Further, the PUSCH may be used for SPS Type 1 in which periodic data transmission is allowed, by receiving rrcConfiguredUplinkGrant as well as information of SPS Type 2, by using RRC. Information of rrcConfiguredUplinkGrant may include resource allocation in the time domain, an offset in the time domain, resource allocation in the frequency domain, a configuration of the DMRS, and the number of times of repeated transmission of the same data (repK). In a case that SPS Type 1 and SPS Type 2 are configured in the same serving cell (in the same component carrier), SPS Type 1 may be prioritized. In a case that the uplink grant of SPS Type 1 and the uplink grant of dynamic scheduling overlap in the time domain in the same serving cell, the uplink grant of dynamic scheduling may override (only the dynamic scheduling is used, such that the uplink grant of SPS Type 1 is overridden). A case that multiple uplink grants overlap in the time domain may mean overlap in at least some of the OFDM symbols, or may mean overlap of partial time in the OFDM symbols in a case that subcarrier spacings (SCS) are different because OFDM symbol lengths are different in this case. Regarding a configuration of SPS Type 1, a configuration is also possible in an Scell that is not activated in RRC, and the uplink grant of SPS Type 1 may be validated after the activation in the Scell in which SPS Type 1 is configured.

The PRACH is used to transmit a preamble used for random access. The PRACH is used for indicating the initial connection establishment procedure, the handover procedure, the connection re-establishment procedure, synchronization (timing adjustment) for uplink transmission, and the request for the PUSCH (UL-SCH) resource.

In the uplink radio communication, an Uplink Reference Signal (UL RS) is used as an uplink physical signal. The uplink reference signal includes a Demodulation Reference Signal (DMRS) and a Sounding Reference Signal (SRS). The DMRS is associated with transmission of the physical uplink-shared channel/physical uplink control channel. For example, the base station apparatus 10 uses the demodulation reference signal to perform channel estimation/channel compensation in a case of demodulating the physical uplink-shared channel/the physical uplink control channel. Regarding an uplink DMRS, a maximum number of OFDM symbols of a front-loaded DMRS and an additional configuration of a DMRS symbol (DMRS-add-pos) are specified by the base station apparatus by using RRC. In a case that the front-loaded DMRS is one OFDM symbol (single symbol DMRS), how different frequency domain mapping is used in frequency domain mapping, a value of a cyclic shift in the frequency domain, and OFDM symbols including the DMRS is specified by using DCI, and in a case that the front-loaded DMRS is two OFDM symbols (double symbol DMRS), a configuration of time spread of length 2 is specified by using DCI in addition to the above.

The Sounding Reference Signal (SRS) is not associated with the transmission of the physical uplink shared channel/the physical uplink control channel. In other words, regardless of whether or not there is uplink data transmission, the terminal apparatus transmits the SRS either periodically or aperiodically. In the periodic SRS, the terminal apparatus transmits the SRS, based on a parameter that is notified from the base station apparatus by using higher layer signaling (for example, RRC). On the other hand, in the aperiodic SRS, the terminal apparatus transmits the SRS, based on the parameter that is notified from the base station apparatus by using higher layer signaling (for example, RRC) and a physical downlink control channel (for example, DCI) indicating transmission timing of the SRS. The base station apparatus 10 uses the SRS to measure an uplink channel state (CSI Measurement). The base station apparatus 10 may perform timing alignment and closed loop transmission power control, based on measurement results obtained through reception of the SRS.

In FIG. 1, at least the following downlink physical channels are used in radio communication of a downlink r31. The downlink physical channels are used for transmitting information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast channel (BCH)) that is used commonly by the terminal apparatuses. The MIB is one of pieces of system information. For example, the MIB includes a downlink transmission bandwidth configuration and a System Frame number (SFN). The MIB may include information indicating at least some of numbers of a slot, a subframe, and a radio frame in which a PBCH is transmitted.

The PDCCH is used to transmit Downlink Control Information (DCI). For the downlink control information, multiple formats based on applications (also referred to as DCI formats) are defined. The DCI format may be defined based on the type and the number of bits of the DCI constituting a single DCI format. The downlink control information includes control information for downlink data transmission and control information for uplink data transmission. The DCI format for downlink data transmission is also referred to as a downlink assignment (or a downlink grant, a DL Grant). The DCI format for uplink data transmission is also referred to as an uplink grant (or an uplink assignment, a UL Grant).

The DCI formats for downlink data transmission include DCI format 1_0, DCI format 1_1, and the like. DCI format 1_0 is used for downlink data transmission for fallback, and includes bits less than those of DCI format 1_1 supporting MIMO or the like. On the other hand, DCI format 1_1 can support MIMO and multiple codeword transmissions, and can be used for notification of a ZP CSI-RS trigger, CBG transmission information, and the like, and in addition, the presence or absence of some of the fields and the number of bits are added according to a configuration of a higher layer (for example, RRC signaling, MAC CEs). A single downlink assignment is used for scheduling a single PDSCH in a single serving cell. The downlink grant may be used at least for scheduling of the PDSCH in the slot/subframe that is the same as the slot/subframe in which the downlink grant is transmitted. The downlink assignment of DCI format 1_0 includes the following fields. Examples of the fields include an identifier of a DCI format, a frequency domain resource assignment (resource block allocation for the PDSCH, resource allocation), a time domain resource assignment, mapping from VRB to PRB, a Modulation and Coding Scheme (MCS, information indicating a modulation order and a coding rate) for the PDSCH, a NEW Data Indicator (NDI) indicating initial transmission or retransmission, information indicating a HARQ process number in the downlink, a Redudancy version (RV) indicating information of redundancy bits added to a codeword at the time of error correction coding, a Downlink Assignment Index (DAI), a Transmission Power Control (TPC) command of the PUCCH, a resource indicator of the PUCCH, and an indicator of HARQ feedback timing from the PDSCH. Note that the DCI format for each downlink data transmission includes information (fields) required for the application among the above-described information. One or both of DCI format 1_0 and DCI format 1_1 may be used for activation and deactivation of downlink SPS.

The DCI formats for uplink data transmission include DCI format 0_0, DCI format 0_1, and the like. DCI format 0_0 is used for uplink data transmission for fallback, and includes bits less than those of DCI format 0_1 supporting MIMO or the like. On the other hand, DCI format 0_1 can support MIMO and multiple codeword transmissions and can be used for notification of an SRS resource indicator, precoding information, information of an antenna port, information of an SRS request, information of a CSI request, CBG transmission information, uplink PTRS association, sequence initialization of the DMRS, and the like, and in addition, the presence or absence of some of the fields and the number of bits are added according to a configuration of a higher layer (for example, RRC signaling). A single uplink grant is used for notifying the terminal apparatus of scheduling of a single PUSCH in a single serving cell. The uplink grant of DCI format 0_0 includes the following fields. Examples of the fields include an identifier of a DCI format, frequency domain resource assignment (information related to a resource block allocation for transmission of the PUSCH and a time domain resource assignment, a frequency hopping flag, information related to an MCS of the PUSCH, an RV, an NDI, information indicating a HARQ process number in the uplink, a TPC command for the PUSCH, and a UL/Supplemental UL (SUL) indicator. One or both of DCI format 0_0 and DCI format 0_1 may be used for activation and deactivation of uplink SPS.

Regarding the MCS for the PDSCH/PUSCH, an index (MCS index) indicating a modulation order and a target coding rate of the PDSCH/the PUSCH can be used. The modulation order is associated with a modulation scheme. The modulation orders “2”, “4”, and “6” indicate “QPSK”, “16 QAM”, and “64 QAM”, respectively. Further, in a case that 256 QAM and 1024 QAM are configured by using a higher layer (for example, RRC signaling), a notification of the modulation orders “8” and “10” is possible, which indicate “256 QAM” and “1024 QAM”, respectively. The target coding rate is used for determination of a transport block size (TBS) being the number of bits to be transmitted, according to the number of resource elements (number of resource blocks) of the PDSCH/PUSCH scheduled in the PDCCH. The communication system 1 (the base station apparatus 10 and the terminal apparatus 20) shares a method of calculating the transport block size, depending on the MCS, the target coding rate, and the number of resource elements (number of resource blocks) allocated for the PDSCH/PUSCH transmission.

The PDCCH is generated by adding a Cyclic Redundancy Check (CRC) to the downlink control information. In the PDCCH, CRC parity bits are scrambled with a prescribed identifier (also referred to as an exclusive OR operation, mask). The parity bits are scrambled with a Cell-Radio Network Temporary Identifier (C-RNTI), a Configured Scheduling (CS)-RNTI, a Temporary C (TC)-RNTI, a Paging (P)-RNTI, a System Information (SI)-RNTI, a Random Access (RA)-RNTI, an INT-RNTI, a Slot Format Indicator (SFI)-RNTI, a TPC-PUSCH-RNTI, a TPC-PUCCH-RNTI, or a TPC-SRS-RNTI. The C-RNTI is an identifier for identifying dynamic scheduling, and the CS-RNTI is an identifier for identifying the terminal apparatus in a cell in SPS/grant free access. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The CS-RNTI is used to periodically allocate a resource for the PDSCH or the PUSCH. The P-RNTI is used to transmit a paging message (Paging Channel (PCH)). The SI-RNTI is used to transmit the SIB, and the RA-RNTI is used to transmit a random access response (a message 2 in a random access procedure). The SFI-RNTI is used for notification of a slot format. The INT-RNTI is used for notification of Pre-emption. The TPC-PUSCH-RNTI, the TPC-PUCCH-RNTI, and the TPC-SRS-RNTI are used for notification of a transmission power control value of the PUSCH, the PUCCH, and the SRS, respectively. Note that the identifier may include the CS-RNTI of each configuration for the sake of multiple configurations of grant free access/SPS. The DCI to which a CRC scrambled with the CS-RNTI is added can be used for activation and deactivation of grant free access, parameter change, and retransmission control (ACK/NACK transmission), and parameters can include resource configurations (a configuration parameter of the DMRS, resources of grant free access in the frequency domain and the time domain, an MCS used in grant free access, the number of times of repetition, presence or absence of frequency hopping, and the like).

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (specific to the cell). That is, the information common to the user equipments in the cell is transmitted using the RRC signaling specific to the cell. The RRC signaling transmitted from the base station apparatus may be a message dedicated to a certain terminal apparatus (also referred to as dedicated signaling). In other words, user equipment-specific (UE-Specific) information is transmitted by using a message that is dedicated to a certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization signal (SS) and a Downlink Reference Signal (DL RS) are used as downlink physical signals.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement). The downlink reference signal can include a Cell-specific Reference Signal (CRS), a Channel state information Reference Signal (CSI-RS), a Discovery Reference Signal (DRS), and a Demodulation Reference Signal (DMRS).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

In the higher layer processing, processing on a layer that is higher than the physical layer is performed, such as a Medium Access Control (MAC) layer, a Packet Data Convergence Protocol (PDCP) layer, a Radio Link Control (RLC) layer, and a Radio Resource Control (RRC) layer.

Processing on a layer that is higher than the physical layer is performed, such as a Medium Access Control (MAC) layer, a Packet Data Convergence Protocol (PDCP) layer, a Radio Link Control (RLC) layer, and a Radio Resource Control (RRC) layer.

In the processing unit of the higher layer, various RNTIs for each terminal apparatus are configured. The RNTI is used for encryption (scrambling) of the PDCCH, the PDSCH, and the like. In the processing of the higher layer, the downlink data (transport block, DL-SCH) allocated to the PDSCH, the system information specific to the terminal apparatus (System Information Block: SIB), the RRC message, the MAC CE, and the like, are generated, or are acquired from the higher node, and are then transmitted. In the processing of the higher layer, various kinds of configuration information of the terminal apparatus 20 are managed. Note that a part of the function of the radio resource control may be performed in the MAC layer or the physical layer.

In the processing of the higher layer, information on the terminal apparatus, such as the function supported by the terminal apparatus (UE capability), is received from the terminal apparatus 20. The terminal apparatus 20 transmits its own function to the base station apparatus 10 by a higher layer signaling (RRC signaling). The information on the terminal apparatus includes information for indicating whether the terminal apparatus supports a prescribed function or information for indicating that the terminal apparatus has completed introduction and testing of the prescribed function. The information for indicating whether the prescribed function is supported includes information for indicating whether the introduction and testing of the prescribed function have been completed.

In a case that the terminal apparatus supports the prescribed function, the terminal apparatus transmits information (parameters) for indicating whether the prescribed function is supported. In a case that the terminal apparatus does not support a prescribed function, the terminal apparatus need not transmit the information (parameters) for indicating whether the prescribed function is supported. In other words, whether the prescribed function is supported is notified based on whether information (parameters) for indicating whether the prescribed function is supported is transmitted. Note that the information (parameters) for indicating whether the prescribed function is supported may be notified by using one bit of 1 or 0.

In FIG. 1, the base station apparatus 10 and the terminal apparatuses 20 support, in the uplink, Multiple Access (MA) using grant free access (also referred to as grant less access, Contention-based access, Autonomous access, Resource allocation for uplink transmission without grant, type 1 configured grant transmission, or the like, hereinafter referred to as grant free access). The grant free access is a scheme in which the terminal apparatus transmits uplink data (physical uplink channel and the like) without performing a procedure for specifying physical resources and transmission timing of data transmission using transmission of the SR performed by the terminal apparatus and the UL Grant (also referred to as the UL Grant using L1 signaling) using the DCI performed by the base station apparatus. Thus, the terminal apparatus receives physical resources (a resource assignment in the frequency domain, a resource assignment in the time domain) and transmission parameters (which may include a cyclic shift and an OCC of the DMRS, an antenna port number, the position and the number of OFDM symbols to which the DMRS is mapped, the number of times of repeated transmission of the same transport, and the like) that are available for the grant free access in advance as a Configured Uplink Grant (rrcConfiguredUplinkGrant, uplink grant being configured) of RRC signaling in addition to an allocation period of available resources, target received power, a value (α) of a fractional TPC, the number of HARQ processes, and an RV pattern used in a case that the same transport is repeatedly transmitted by using RRC signaling (SPS-config), and only in a case that transmission data is included in a buffer, the terminal apparatus can perform data transmission by using the configured physical resources. In other words, in a case that a higher layer does not deliver a transport block to be transmitted in the grant free access, data transmission of the grant free access is not performed. The terminal apparatus receives SPS-config; however, in a case that the Configured Uplink Grant of RRC signaling is not received, it is also possible to perform similar data transmission in SPS (type 2 configured grant transmission) through activation of SPS using the UL Grant.

The grant free access includes the following two types. Type 1 configured grant transmission (UL-TWG-type 1) being the first type employs a scheme in which the base station apparatus transmits transmission parameters related to the grant free access to the terminal apparatus by using higher layer signaling (for example, RRC), and further transmits allow start (activation, RRC setup) and allow end (deactivation, RRC release) of the data transmission of the grant free access and change of the transmission parameters as well by using higher layer signaling. Here, the transmission parameters related to the grant free access may include physical resources (resource assignment in the time domain and the frequency domain) available for the data transmission of the grant free access, a period of the physical resources, an MCS, presence or absence of repeated transmission, the number of times of repetition, a configuration of an RV used in a case that repeated transmission is performed, presence or absence of frequency hopping, a hopping pattern, a configuration of the DMRS (the number of OFDM symbols in the front-loaded DMRS, a configuration of a cyclic shift and time spread, or the like), the number of HARQ processes, information of a transformer precoder, and information related to a configuration related to a TPC. The transmission parameters related to the grant free access and the allow start of the data transmission may be configured simultaneously. Alternatively, after the transmission parameters related to the grant free access are configured, the allow start of the data transmission of the grant free access may be configured at a different timing (in a case of the SCell, using SCell activation or the like). Type 2 configured grant transmission (UL-TWG-type 2) being the second type employs a scheme in which the base station apparatus transmits transmission parameters related to the grant free access to the terminal apparatus by using higher layer signaling (for example, RRC), and allow start (activation) and allow end (deactivation) of the data transmission of the grant free access and change of the transmission parameters are transmitted by using DCI (L1 signaling). Here, a period of the physical resource, the number of times of repetition, a configuration of an RV used in a case that repeated transmission is performed, the number of HARQ processes, information of a transformer precoder, and information related to a configuration related to a TPC are included by using RRC, and physical resources available for the grant free access (allocation of resource blocks) may be included in the allow start (activation) using DCI. The transmission parameters related to the grant free access and the allow start of the data transmission may be configured simultaneously. Alternatively, after the transmission parameters related to the grant free access are configured, the allow start of the data transmission of the grant free access may be configured at a different timing. The present invention may be applied to either type of the grant free access described above.

Meanwhile, a technique referred to as Semi-Persistent Scheduling (SPS) has been introduced in LTE, and periodic resource allocation is possible mainly in the application of Voice over Internet Protocol (VoIP). In SPS, with the use of DCI, the allow start (activation) is performed with the UL Grant including transmission parameters such as specification of physical resources (allocation of resource blocks) and the MCS. Thus, a start procedure of the two types (UL-TWG-type 1) whose allow start (activation) is caused by higher layer signaling (for example, RRC) of the grant free access is different from that of SPS. UL-TWG-type 2 is the same in causing of the allow start (activation) using DCI (L1 signaling), but may be different in availability in the SCell, the BWP, and the SUL and notification of the number of times of repetition and a configuration of an RV used in a case that repeated transmission is performed using RRC signaling. The base station apparatus may perform scrambling by using different types of RNTIs for the DCI (L1 signaling) used in the grant free access (UL-TWG-type 1 and UL-TWG-type 2) and the DCI used in the dynamic scheduling, or may perform scrambling by using the same RNTI for the DCI used in retransmission control of the UL-TWG-type 1 and the DCI used in activation, deactivation, and retransmission control of UL-TWG-type 2.

The base station apparatus 10 and the terminal apparatuses 20 may support non-orthogonal multiple access as well as orthogonal multiple access. Note that the base station apparatus 10 and the terminal apparatuses 20 can support both the grant free access and scheduled access (dynamic scheduling). Here, uplink scheduled access refers to a scheme in which the terminal apparatus 20 performs data transmission in the following procedure. The terminal apparatus 20 requests radio resources for transmitting uplink data from the base station apparatus 10 by using the Random Access Procedure and the SR. The base station apparatus provides the UL Grant to each terminal apparatus by using the DCI, based on the RACH and the SR. In a case that the terminal apparatus receives the UL Grant for control information from the base station apparatus, the terminal apparatus transmits uplink data using a prescribed radio resource, based on an uplink transmission parameter included in the UL Grant.

The downlink control information for physical channel transmission in the uplink may include a shared field shared between the scheduled access and the grant free access. In this case, in a case that the base station apparatus 10 indicates transmission of the uplink physical channel using the grant free access, the base station apparatus 10 and the terminal apparatus 20 interpret a bit sequence stored in the shared field in accordance with a configuration for the grant free access (e.g., a look-up table defined for the grant free access). Similarly, in a case that the base station apparatus 10 indicates transmission of the uplink physical channel using the scheduled access, the base station apparatus 10 and the terminal apparatus 20 interpret the shared field in accordance with a configuration for the scheduled access. Transmission of the uplink physical channel in the grant free access is referred to as Asynchronous data transmission. Note that the transmission of the uplink physical channel in the scheduled is referred to as Synchronous data transmission.

In the grant free access, the terminal apparatus 20 may randomly select a radio resource for transmission of uplink data. For example, the terminal apparatus 20 has been notified, by the base station apparatus 10, of multiple candidates for available radio resources as a resource pool, and randomly selects a radio resource from the resource pool. In the grant free access, the radio resource in which the terminal apparatus 20 transmits the uplink data may be configured in advance by the base station apparatus 10. In this case, the terminal apparatus 20 transmits the uplink data using the radio resource configured in advance without receiving the UL Grant (including specification of the physical resource) of DCI. The radio resource includes multiple uplink multiple access resources (resources to which the uplink data can be mapped). The terminal apparatus 20 transmits the uplink data by using one or more uplink multiple access resources selected from the multiple uplink multiple access resources. Note that the radio resource in which the terminal apparatus 20 transmits the uplink data may be predetermined in the communication system including the base station apparatus 10 and the terminal apparatus 20. The radio resource for transmission of the uplink data may be notified to the terminal apparatus 20 by the base station apparatus 10 using a physical broadcast channel (e.g., Physical Broadcast Channel (PBCH)/Radio Resource Control (RRC)/system information (e.g. System Information Block (SIB)/physical downlink control channel (downlink control information, e.g., Physical Downlink Control Channel (PDCCH), Enhanced PDCCH (EPDCCH), MTC PDCCH (MPDCCH), or Narrowband PDCCH (NPDCCH).

In the grant free access, the uplink multiple access resource includes a multiple access physical resource and a Multi-Access Signature Resource. The multiple access physical resource is a resource including time and frequency. The multiple access physical resource and the multi-access signature resource may be used to identify the uplink physical channel transmitted by each terminal apparatus. The resource blocks are units to which the base station apparatus 10 and the terminal apparatus 20 are capable of mapping the physical channel (e.g., the physical data shared channel or the physical control channel). Each of the resource blocks includes one or more subcarriers (e.g., 12 subcarriers or 16 subcarriers) in a frequency domain.

The multi-access signature resource includes at least one multi-access signature of multiple multi-access signature groups (also referred to as multi-access signature pools). The multi-access signature is information indicating a characteristic (mark or indicator) that distinguishes (identifies) the uplink physical channel transmitted by each terminal apparatus. Examples of the multi-access signature include a spatial multiplexing pattern, a spreading code pattern (a Walsh code, an Orthogonal Cover Code (OCC), a cyclic shift for data spreading, the sparse code, or the like), an interleaved pattern, a demodulation reference signal pattern (a reference signal sequence, the cyclic shift, the OCC, or IFDM)/an identification signal pattern, and transmit power, at least one of which is included in the multi-access signature. In the grant free access, the terminal apparatus 20 transmits the uplink data by using one or more multi-access signatures selected from the multi-access signature pool. The terminal apparatus 20 can notify the base station apparatus 10 of available multi-access signatures. The base station apparatus 10 can notify the terminal apparatus of a multi-access signature used by the terminal apparatus 20 to transmit the uplink data. The base station apparatus 10 can notify the terminal apparatus 20 of an available multi-access signature group by the terminal apparatus 20 to transmit the uplink data. The available multi-access signature group may be notified by using the broadcast channel/RRC/system information/downlink control channel. In this case, the terminal apparatus 20 can transmit the uplink data by using a multi-access signature selected from the notified multi-access signature group.

The terminal apparatus 20 transmits the uplink data by using a multiple access resource. For example, the terminal apparatus 20 can map the uplink data to a multiple access resource including a multi-carrier signature resource including one multiple access physical resource, a spreading code pattern, and the like. The terminal apparatus 20 can allocate the uplink data to a multiple access resource including a multi-carrier signature resource including one multiple access physical resource and an interleaved pattern. The terminal apparatus 20 can also map the uplink data to a multiple access resource including a multi-access signature resource including one multiple access physical resource and a demodulation reference signal pattern/identification signal pattern. The terminal apparatus 20 can also map the uplink data to a multiple access resource including one multiple access physical resource and a multi-access signature resource including a transmit power pattern (e.g., the transmit power for each of the uplink data may be configured to cause a difference in receive power at the base station apparatus 10). In such grant free access, the communication system of the present embodiment may allow the uplink data transmitted by the multiple terminal apparatuses 20 to overlap (superimpose, spatially multiplex, non-orthogonally multiplex, or collide) with one another in the uplink multiple access physical resource.

The base station apparatus 10 detects, in the grant free access, a signal of the uplink data transmitted by each terminal apparatus. To detect the uplink data signal, the base station apparatus 10 may include Symbol Level Interference Cancellation (SLIC) in which interference is canceled based on a demodulation result for an interference signal, Codeword Level Interference Cancellation (CWIC, also referred to as Sequential Interference Canceler (SIC) or Parallel Interference Canceler (PIC)) in which interference is canceled based on the decoding result for the interference signal, turbo equalization, maximum likelihood detection (MLD, Reduced complexity maximum likelihood detection (R-MLD)) in which transmit signal candidates are searched for the most probable signal, Enhanced Minimum Mean Square Error-Interference Rejection Combining (EMMSE-IRC) in which interference signals are suppressed by linear computation, signal detection based on message passing (Belief propagation (BP), Matched Filter (MF)-BP in which a matched filter is combined with BP, or the like.

FIG. 2 is a diagram illustrating an example of a radio frame structure for a communication system according to the present embodiment. The radio frame structure indicates a configuration of multiple access physical resources in a time domain. One radio frame includes multiple slots (may include multiple subframes). FIG. 2 is an example in which one radio frame includes 10 slots. The terminal apparatus 20 has a subcarrier spacing used as a reference (reference numerology). The subframe includes multiple OFDM symbols generated at the subcarrier spacings used as the reference. FIG. 2 is an example in which the subcarrier spacing is 15 kHz, one frame includes 10 slots, one subframe includes one slot, and one slot includes 14 OFDM symbols. In a case that the subcarrier spacing is 15 kHz×2^{μ} (μ is an integer of 0 or greater), one frame includes 2^{μ}×10 slots, and one subframe includes 2^{μ} slots.

FIG. 2 illustrates a case where the subcarrier spacing used as the reference is the same as a subcarrier spacing used for the uplink data transmission. The communication system according to the present embodiment may use slots as minimum units to which the terminal apparatus 20 maps the physical channel (e.g., the physical data shared channel or the physical control channel). In this case, in the multiple access physical resource, one slot is defined as a resource block unit in the time domain. Further, in the communication system according to the present embodiment, a minimum unit in which the terminal apparatus 20 maps the physical channel may be one or multiple OFDM symbols (for example, 2 to 13 OFDM symbols). For the base station apparatus 10, the one or multiple OFDM symbols are used as the resource block unit in the time domain. The base station apparatus 10 may notify the terminal apparatus 20 of the minimum unit in which the physical channel is mapped by means of signaling.

FIG. 3 is a schematic block diagram illustrating a configuration of the base station apparatus 10 according to the present embodiment. The base station apparatus 10 includes a receive antenna 202, a receiver (receiving step) 204, a higher layer processing unit (higher layer processing step) 206, a controller (control step) 208, a transmitter (transmitting step) 210, and a transmit antenna 212. The receiver 204 includes a radio receiving unit (radio receiving step) 2040, an FFT unit 2041 (FFT step), a demultiplexing unit (demultiplexing step) 2042, a channel estimation unit (channel estimation step) 2043, and a signal detection unit (signal detection step) 2044. The transmitter 210 includes a coding unit (coding step) 2100, a modulation unit (modulation step) 2102, a multiple access processing unit (multiple access processing step) 2106, a multiplexing unit (multiplexing step) 2108, a radio transmitting unit (radio transmitting step) 2110, an IFFT unit (IFFT step) 2109, a downlink reference signal generation unit (downlink reference signal generation step) 2112, and a downlink control signal generation unit (downlink control signal generation step) 2113.

The receiver 204 demultiplexes, demodulates, and decodes an uplink signal (uplink physical channel, uplink physical signal) received from the terminal apparatus 10 via the receive antenna 202. The receiver 204 outputs a control channel (control information) separated from the received signal to the controller 208. The receiver 204 outputs a decoding result to the higher layer processing unit 206. The receiver 204 acquires the SR included in the received signal, the ACK/NACK for downlink data transmission, and the CSI.

The radio receiving unit 2040 converts the uplink signal received through the receive antenna 202 into a baseband signal by down-conversion, removes unnecessary frequency components from the baseband signal, controls an amplification level such that a signal level is suitably maintained, performs orthogonal demodulation based on an in-phase component and an orthogonal component of the received signal, and converts the resulting orthogonally-demodulated analog signal into a digital signal. The radio receiving unit 2040 removes a portion of the digital signal resulting from the conversion, the portion corresponding to a Cyclic Prefix (CP). The FFT unit 2041 performs a fast Fourier transform on the downlink signal from which CP has been removed (demodulation processing for OFDM modulation), and extracts the signal in the frequency domain.

The channel estimation unit 2043 uses the demodulation reference signal to perform channel estimation for signal detection for the uplink physical channel. The channel estimation unit 2043 receives as inputs, from the controller 208, the resources to which the demodulation reference signal is mapped and the demodulation reference signal sequence allocated to each terminal apparatus. The channel estimation unit 2043 uses the demodulation reference signal sequence to measure the channel state between the base station apparatus 10 and the terminal apparatus 20. In a case of the grant free access, the channel estimation unit 2043 can identify the terminal apparatus by using the result of channel estimation (impulse response and frequency response with the channel state) (the channel estimation unit 2043 is thus also referred to as an identification unit). The channel estimation unit 2043 determines that an uplink physical channel has been transmitted by the terminal apparatus 20 associated with the demodulation reference signal from which the channel state has been successfully extracted. In the resource on which the uplink physical channel is determined by the channel estimation unit 2043 to have been transmitted, the demultiplexing unit 2042 extracts the signal in the frequency domain input from the FFT unit 2041 (the signal includes signals from multiple terminal apparatuses 20).

The demultiplexing unit 2042 separates and extracts the uplink physical channel (physical uplink control channel, physical uplink shared channel) and the like included in the extracted uplink signal in the frequency domain. The demultiplexing unit outputs the physical uplink channel to the signal detection unit 2044/controller 208.

The signal detection unit 2044 uses the channel estimation result estimated by the channel estimation unit 2043 and the signal in the frequency domain input from the demultiplexing unit 2042 to detect a signal of uplink data (uplink physical channel) from each terminal apparatus. The signal detection unit 2044 performs detection processing for a signal from the terminal apparatus 20 associated with the demodulation reference signal (demodulation reference signal from which the channel state has been successfully extracted) allocated to the terminal apparatus 20 determined to have transmitted the uplink data.

FIG. 4 is a diagram illustrating an example of the signal detection unit according to the present embodiment. The signal detection unit 2044 includes an equalization unit 2504, multiple access signal separation units 2506-1 to 2506-u, IDFT units 2508-1 to 2508-u, demodulation units 2510-1 to 2510-u, and decoding units 2512-1 to 2512-u. In a case of the grant free access, u is the number of terminal apparatuses determined by the channel estimation unit 2043 to have transmitted uplink data (for which the channel state has been successfully extracted) on the same multiple access physical resource or overlapping multiple access physical resources (at the same time and at the same frequency). In a case of the scheduled access, u represents the number of terminal apparatuses that are allowed to perform uplink data transmission in the same or overlapping multiple access physical resource (at the same time, for example, in the same OFDM symbol or slot) using DCI. Each of the units constituting the signal detection unit 2044 is controlled using the configuration related to the grant free access for each terminal apparatus input from the controller 208.

The equalization unit 2504 generates an equalization weight based on the MMSE standard, from the frequency response input from the channel estimation unit 2043. Here, MRC and ZF may be used for the equalization processing. The equalization unit 2504 multiplies the equalization weight by the signal in the frequency domain input from the demultiplexing unit 2042 (including the signal of each terminal apparatus), and extracts the signal in the frequency domain of each terminal apparatus. The equalization unit 2504 outputs the equalized signal in the frequency domain from each terminal apparatus to the IDFT units 2508-1 to 2508-u. Here, in a case that data is to be detected that is transmitted by the terminal apparatus 20 and that uses the DFTS-OFDM signal waveform, the signal in the frequency domain is output to the IDFT units 2508-1 to 2508-u. In a case that data is to be received that is transmitted by the terminal apparatus 20 and that uses the OFDM signal waveform, the signal in the frequency domain is output to the multiple access signal separation units 2506-1 to 2506-u.

The IDFT units 2508-1 to 2508-u convert the equalized signal in the frequency domain from each terminal apparatus into a signal in the time domain. Note that the IDFT units 2508-1 to 2508-u correspond to processing performed by the DFT unit of the terminal apparatus 20. The multiple access signal separation units 2506-1 to 2506-u separate the signal multiplexed by the multi-access signature resource from the signal in the time domain from each terminal apparatus after conversion with the IDFT (multiple access signal separation processing). For example, in a case that code spreading is used as a multi-access signature resource, each of the multiple access signal separation units 2506-1 to 2506-u performs inverse spreading processing using the spreading code sequence assigned to each terminal apparatus. Note that, in a case that interleaving is applied as a multi-access signature resource, de-interleaving is performed on the signal in the time domain from each terminal apparatus after conversion with the IDFT (deinterleaving unit).

The demodulation units 2510-1 to 2510-u receive as an input, from the controller 208, pre-notified or predetermined information (BPSK, QPSK, 16 QAM, 64 QAM, 256 QAM, or the like) about the modulation scheme of each terminal apparatus. Based on the information about the modulation scheme, the demodulation units 2510-1 to 2510-u perform demodulation processing on the separated multiple access signal, and output a Log Likelihood Ratio (LLR) of the bit sequence.

The decoding units 2512-1 to 2512-u receive as an input, from the controller 208, pre-notified or predetermined information about the coding rate. The decoding units 2512-1 to 2512-u perform decoding processing on sequences of the LLR output from the demodulation unit 2510-1 to 2510-u, and output the decoded uplink data/uplink control information to the higher layer processing unit 206. In order to perform cancellation processing such as a Successive Interference Canceller (SIC) or turbo equalization, the decoding units 2512-1 to 2512-u may perform the cancellation processing by generating a replica from external LLR or post LLR output from the decoding units. A difference between the external LLR and the post LLR is whether to subtract, from the decoded LLR, the pre LLR input to each of the decoding units 2512-1 to 2512-u. In a case that the number of repetitions of SIC or turbo equalization reaches a prescribed value, the decoding units 2512-1 to 2512-u may perform hard decision on the LLR resulting from the decoding processing, and output the bit sequence of the uplink data for each terminal apparatus to the higher layer processing unit 206. Note that the present invention is not limited to the signal detection using the turbo equalization processing. In the present invention, signal detection based on replica generation and using no interference cancellation, maximum likelihood detection, EMMSE-IRC, or the like can also be used.

The controller 208 controls the receiver 204 and the transmitter 210 by using the configuration information related to the uplink reception/configuration information related to the downlink transmission (which is notified from the base station apparatus to the terminal apparatus by using DCI, RRC, SIB, or the like) included in the uplink physical channel (physical uplink control channel, physical uplink shared channel, or the like). The controller 208 acquires the configuration information related to the uplink reception and/or the configuration information related to the downlink transmission from the higher layer processing unit 206. In a case that the transmitter 210 transmits the physical downlink control channel, the controller 208 generates Downlink Control information (DCI) and outputs the resultant information to the transmitter 210. Note that some of the functions of the controller 108 can be included in the higher layer processing unit 102. Note that the controller 208 may control the transmitter 210 in accordance with the parameter of the CP length added to the data signal.

The higher layer processing unit 206 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 206 generates information needed to control the transmitter 210 and the receiver 204, and outputs the resultant information to the controller 208. The higher layer processing unit 206 outputs downlink data (e.g., the DL-SCH), broadcast information (e.g., the BCH), a Hybrid Automatic Request indicator (HARQ indicator), and the like to the transmitter 210. The higher layer processing unit 206 inputs, from the receiver 204, information related to a function of the terminal apparatus (UE capability) supported from the terminal apparatus. For example, the higher layer processing unit 206 receives the information related to the function of the terminal apparatus by using signaling of the RRC layer.

The information related to the function of the terminal apparatus includes information indicating whether the terminal apparatus supports a prescribed function, or information indicating that the terminal apparatus has completed introduction and testing of a prescribed function. The information for indicating whether the prescribed function is supported includes information for indicating whether the introduction and testing of the prescribed function have been completed. In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified based on whether information (parameters) for indicating whether the prescribed function is supported is transmitted. Note that the information (parameters) for indicating whether the prescribed function is supported may be notified by using one bit of 1 or 0.

The information related to the function of the terminal apparatus includes information indicating that the grant free access is supported (information as to whether or not each of UL-TWG-type 1 and UL-TWG-type 2 is supported). In a case that multiple functions corresponding to the grant free access are provided, the higher layer processing unit 206 can receive information indicating whether the grant free access is supported on a function-by-function basis. The information indicating that the grant free access is supported includes information indicating the multiple access physical resource and multi-access signature resource supported by the terminal apparatus. The information indicating that the grant free access is supported may include a configuration of a lookup table for the configuration of the multiple access physical resource and the multi-access signature resource. The information indicating that the grant free access is supported may include some or all of an antenna port, a capability corresponding to multiple tables indicating a scrambling identity and the number of layers, a capability corresponding to a prescribed number of antenna ports, and a capability corresponding to a prescribed transmission mode. The transmission mode is determined by the number of antenna ports, transmission diversity, the number of layers, and whether support of the grant free access and the like are provided.

The information related to the function of the terminal apparatus may include information indicating that the function related to URLLC is supported. For example, as the DCI format for the uplink dynamic scheduling, the SPS/grant free access, the downlink dynamic scheduling, and the SPS, there is a compact DCI format that has a small total number of bits of the fields in the DCI format, and the information related to the function of the terminal apparatus may include information indicating that receiving processing (blind decoding) of a compact DCI format is supported. The DCI format is transmitted by being mapped in a search space of the PDCCH, and its number of resources available for each aggregation level is determined in advance. Accordingly, in a case that a total number of bits of the fields in the DCI format is large, transmission with a high coding rate is performed, and in a case that a total number of bits of the fields in the DCI format is small, transmission with a low coding rate is performed. Thus, in a case that high reliability such as URLLC is required, it is preferable that the compact DCI format be used. Note that, regarding the DCI format, in LTE and NR, the DCI format is mapped to predetermined resource elements (search space). Thus, in a case that the number of resource elements (aggregation level) is fixed, a DCI format having a large payload size is transmitted with a high coding rate as compared to a DCI format having a small payload size, which makes it difficult to achieve high reliability.

The information related to the function of the terminal apparatus may include information indicating that the function related to carrier aggregation is supported. The information related to the function of the terminal apparatus may include information indicating that the function related to simultaneous transmission (also including a case of overlapping in the time domain, overlapping in at least some of the OFDM symbols) of multiple component carriers (serving cells) is supported.

The higher layer processing unit 206 manages various types of configuration information about the terminal apparatus. Some of the various types of configuration information are input to the controller 208. The various types of configuration information are transmitted from the base station apparatus 10 via the transmitter 210 using the downlink physical channel. The various types of configuration information include configuration information related to the grant free access input from the transmitter 210. The configuration information related to the grant free access includes configuration information about the multiple access resources (multiple access physical resources and multi-access signature resources). For example, the configuration information related to the grant free access may include a configuration related to the multi-access signature resource (configuration related to processing performed based on a mark for identifying the uplink physical channel transmitted by the terminal apparatus 20), such as an uplink resource block configuration (the start position of the OFDM symbol to be used and the number of OFDM symbols/the number of resource blocks), a configuration of the demodulation reference signal/identification signal (reference signal sequence, cyclic shift, OFDM symbols to be mapped, and the like), a spreading code configuration (Walsh code, Orthogonal Cover Code (OCC), sparse code, spreading rates of these spreading codes, and the like), an interleave configuration, a transmit power configuration, a transmit and/or receive antenna configuration, and a transmit and/or receive beamforming configuration. These multi-access signature resources may be directly or indirectly associated (linked) with one another. The association of the multi-access signature resources is indicated by a multi-access signature process index. The configuration information related to the grant free access may include the configuration of the look-up table for the configuration of the multiple access physical resource and multi-access signature resource. The configuration information related to the grant free access may include setup of the grant free access, information indicating release, ACK/NACK reception timing information for uplink data signals, retransmission timing information for uplink data signals, and the like.

Based on the configuration information related to the grant free access notified as the control information, the higher layer processing unit 206 manages multiple access resources (multiple access physical resources, multi-access signature resources) of uplink data (transport blocks) in a grant free. Based on the configuration information related to the grant free access, the higher layer processing unit 206 outputs, to the controller 208, information used to control the receiver 204.

The higher layer processing unit 206 outputs generated downlink data (e.g., DL-SCH) to the transmitter 210. The downlink data may include a field storing the UE ID (RNTI). The higher layer processing unit 206 adds the CRC to the downlink data. CRC parity bits are generated using the downlink data. The CRC parity bits are scrambled with the UE ID (RNTI) allocated to the terminal apparatus as a destination (the scrambling is also referred to as an exclusive-OR operation, masking, or ciphering). Note that, as described above, the RNTI has multiple types, and different RNTIs are used depending on data to be transmitted or the like.

The higher layer processing unit 206 generates or acquires from a higher node, system information (MIB, SIB) to be broadcast. The higher layer processing unit 206 outputs, to the transmitter 210, the system information to be broadcast. The system information to be broadcast can include information indicating that the base station apparatus 10 supports the grant free access. The higher layer processing unit 206 can include, in the system information, a portion or all of the configuration information related to the grant free access (such as the configuration information related to the multiple access resources such as the multiple access physical resource, the multi-access signature resource). The uplink system control information is mapped to the physical broadcast channel/physical downlink shared channel in the transmitter 210.

The higher layer processing unit 206 generates or acquires from a higher node, downlink data (transport blocks) to be mapped to the physical downlink shared channel, system information (SIB), an RRC message, a MAC CE, and the like, and outputs the downlink data and the like to the transmitter 210. The higher layer processing unit 206 can include, in the higher layer signaling, some or all of the configuration information related to the grant free access and parameters indicating setup and/or release of the grant free access. The higher layer processing unit 206 may generate a dedicated SIB for notifying the configuration information related to the grant free access.

The higher layer processing unit 206 maps the multiple access resources to the terminal apparatuses 20 supporting the grant free access. The base station apparatus 10 may hold a lookup table of configuration parameters for the multi-access signature resource. The higher layer processing unit 206 allocates each configuration parameter to the terminal apparatuses 20. The higher layer processing unit 206 uses the multi-access signature resource to generate configuration information related to the grant free access for each terminal apparatus. The higher layer processing unit 206 generates a downlink shared channel including a portion or all of the configuration information related to the grant free access for each terminal apparatus. The higher layer processing unit 206 outputs, to the controller 208/transmitter 210, the configuration information related to the grant free access.

The higher layer processing unit 206 configures a UE ID for each terminal apparatus and notifies the terminal apparatus of the UE ID. As the UE ID, a Cell Radio Network Temporary Identifier (RNTI) can be used. The UE ID is used for the scrambling of the CRC added to the downlink control channel and the downlink shared channel. The UE ID is used for scrambling of the CRC added to the uplink shared channel. The UE ID is used to generate an uplink reference signal sequence. The higher layer processing unit 206 may configure an SPS/grant free access-specific UE ID. The higher layer processing unit 206 may configure the UE ID separately depending on whether or not the terminal apparatus supports the grant free access. For example, in a case that the downlink physical channel is transmitted in the scheduled access and the uplink physical channel is transmitted in the grant free access, the UE ID for the downlink physical channel may be configured separately from the UE ID for the downlink physical channel. The higher layer processing unit 206 outputs the configuration information related to the UE ID to the transmitter 210/controller 208/receiver 204.

The higher layer processing unit 206 determines the coding rate, the modulation scheme (or MCS), and the transmit power for the physical channels (physical downlink shared channel, physical uplink shared channel, and the like). The higher layer processing unit 206 outputs the coding rate/modulation scheme/transmit power to the transmitter 210/controller 208/receiver 204. The higher layer processing unit 206 can include the coding rate/modulation scheme/transmit power in higher layer signaling.

In a case that downlink data to be transmitted is generated, the transmitter 210 transmits the physical downlink shared channel. In a case that the transmitter 210 transmits resources for data transmission by using the DL Grant, the transmitter 210 may transmit the physical downlink shared channel by using the scheduled access, and may transmit the physical downlink shared channel of SPS in a case that SPS is activated. The transmitter 210 generates the physical downlink shared channel and the demodulation reference signal/control signal associated with the physical downlink shared channel in accordance with the configuration related to the scheduled access/SPS input from the controller 208.

The coding unit 2100 codes the downlink data input from the higher layer processing unit 206 by using the predetermined coding scheme/coding scheme configured by the controller 208 (the coding includes repetitions). The coding scheme may involve application of convolutional coding, turbo coding, Low Density Parity Check (LDPC) coding, Polar coding, and the like. The LDPC code may be used for data transmission, whereas the Polar code may be used for transmission of the control information. Different error correction coding may be used depending on the downlink channel to be used. Different error correction coding may be used depending on the size of the data or control information to be transmitted. For example, the convolution code may be used in a case that the data size is smaller than a prescribed value, and otherwise the correction coding described above may be used. For the coding described above, in addition to a coding rate of 1/3, a mother code such as a low coding rate of 1/6 or 1/12 may be used. In a case that a coding rate higher than the mother code is used, the coding rate used for data transmission may be achieved by rate matching (puncturing). The modulation unit 2102 modulates coded bits input from the coding unit 2100, in compliance with a modulation scheme notified in the downlink control information or a modulation scheme predetermined for each channel, such as BPSK, QPSK, 16 QAM, 64 QAM, or 256 QAM (the modulation scheme may include R/2 shift BPSK or R/4 shift QPSK).

The multiple access processing unit 2106 performs signal conversion such that the base station apparatus 10 can achieve signal detection even in a case that multiple data are multiplexed on a sequence output from the modulation unit 2102 in accordance with multi-access signature resource input from the controller 208. In a case that the multi-access signature resource is configured as spreading, multiplication by the spreading code sequence is performed according to the configuration of the spreading code sequence. Note that, in a case that interleaving is configured as a multi-access signature resource in the multiple access processing unit 2106, the multiple access processing unit 2106 can be replaced with the interleave unit. The interleave unit performs interleave processing on the sequence output from the modulation unit 2102 in accordance with the configuration of the interleave pattern input from the controller 208. In a case that code spreading and interleaving are configured as a multi-access signature resource, the multiple access processing unit 2106 of the transmitter 210 performs spreading processing and interleaving. A similar operation is performed even in a case that any other multi-access signature resource is applied, and the sparse code or the like may be applied.

In a case that OFDM is used as the signal waveform, the multiple access processing unit 2106 inputs a multiple-access-processed signal to the multiplexing unit 2108. The downlink reference signal generation unit 2112 generates a demodulation reference signal in accordance with the configuration information about the demodulation reference signal input from the controller 208. Regarding the configuration information of the demodulation reference signal/identification signal, a sequence that is determined according to a predetermined rule is generated based on information such as the number of OFDM symbols notified by using the downlink control information by the base station apparatus, an OFDM symbol position to which the DMRS is mapped, a cyclic shift, and spread in the time domain.

The multiplexing unit 2108 multiplexes (maps or allocates) the downlink physical channel and the downlink reference signal to resource elements for each transmit antenna port. In a case that the SCMA is used, the multiplexing unit 2108 maps the downlink physical channel to resource elements in accordance with an SCMA resource pattern input from the controller 208.

The IFFT unit 2109 performs the Inverse Fast Fourier Transform (IFFT) on the multiplexed signal to perform OFDM modulation to generate OFDM symbols. The radio transmitting unit 2110 adds CPs to the OFDM-modulated symbols to generate a baseband digital signal. Furthermore, the radio transmitting unit 2110 converts the baseband digital signal into an analog signal, removes the excess frequency components from the analog signal, converts the signal into a carrier frequency by up-conversion, performs power amplification, and transmits the resultant signal to the terminal apparatus 20 via the transmit antenna 212. The radio transmitting unit 2110 includes a transmission power control function (transmission power controller). The transmission power control follows configuration information about the transmit power input from the controller 208. Note that, in a case that FBMC, UF-OFDM, or F-OFDM is applied, filtering is performed on the OFDM symbols in units of subcarriers or sub-bands.

FIG. 5 is a schematic block diagram illustrating a configuration of the terminal apparatus 20 according to the present embodiment. The base station apparatus 10 includes a higher layer processing unit (higher layer processing step) 102, a transmitter (transmitting step) 104, a transmit antenna 106, a controller (control step) 108, a receive antenna 110, and a receiver (receiving step) 112. The transmitter 104 includes a coding unit (coding step) 1040, a modulation unit (modulation step) 1042, a multiple access processing unit (multiple access processing step) 1043, a multiplexing unit (multiplexing step) 1044, a DFT unit (DFT step) 1045, an uplink control signal generation unit (uplink control signal generation step) 1046, an uplink reference signal generation unit (uplink reference signal generation step) 1048, an IFFT unit 1049 (IFFT step), and a radio transmitting unit (radio transmitting step) 1050. The receiver 112 includes a radio receiving unit (radio receiving step) 1120, an FFT unit (FFT step) 1121, a channel estimation unit (channel estimating step) 1122, a demultiplexing unit (demultiplexing step) 1124, and a signal detection unit (signal detecting step) 1126.

The higher layer processing unit 102 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 102 generates information needed to control the transmitter 104 and the receiver 112, and outputs the resultant information to the controller 108. The higher layer processing unit 102 outputs uplink data (for example, the UL-SCH), uplink control information, and the like to the transmitter 104.

The higher layer processing unit 102 transmits information related to the terminal apparatus, such as the function of the terminal apparatus (UE capability) and the like, from the base station apparatus 10 (via the transmitter 104). The information related to the terminal apparatus includes information indicating that reception/detection/blind decoding of the grant free access and the compact DCI is supported, information indicating whether the grant free access is supported on a function-by-function basis. The information indicating that the grant free access is supported and the information indicating whether the grant free access is supported on a function-by-function basis may be distinguished from each other based on the transmission mode.

Based on the various types of configuration information input from the higher layer processing unit 102, the controller 108 controls the transmitter 104 and the receiver 112. The controller 108 generates the uplink control information (UCI), based on the configuration information related to the control information input from the higher layer processing unit 102, and outputs the generated uplink control information to the transmitter 104.

The transmitter 104 codes and modulates the uplink control information, the uplink shared channel, and the like input from the higher layer processing unit 102 for each terminal apparatus, to generate a physical uplink control channel, and a physical uplink shared channel. The coding unit 1040 codes the uplink control information and the uplink shared channel by using the coding scheme that is predetermined/notified by using the control information (the coding includes repetitions). The coding scheme may involve application of convolutional coding, turbo coding, Low Density Parity Check (LDPC) coding, Polar coding, and the like. The modulation unit 1042 modulates the coded bits input from the coding unit 1040 by using a modulation scheme that is predetermined/notified by using the control information, such as the BPSK, QPSK, 16 QAM, 64 QAM, or 256 QAM.

The multiple access processing unit 1043 performs signal conversion such that the base station apparatus 10 can achieve signal detection even in a case that multiple data are multiplexed on a sequence output from the modulation unit 1042 in accordance with multi-access signature resource input from the controller 108. In a case that the multi-access signature resource is configured as spreading, multiplication by the spreading code sequence is performed according to the configuration of the spreading code sequence. The configuration of the spreading code sequence may be associated with other configurations of the grant free access such as the demodulation reference signal/identification signal. Note that the multiple access processing may be performed on the sequence after the DFT processing. Note that, in a case that interleaving is configured as a multi-access signature resource in the multiple access processing unit 1043, the multiple access processing unit 1043 can be replaced with the interleave unit. The interleave unit performs interleave processing on the sequence output from the DFT unit in accordance with the configuration of the interleave pattern input from the controller 108. In a case that code spreading and interleaving are configured as a multi-access signature resource, the multiple access processing unit 1043 of the transmitter 104 performs spreading processing and interleaving. A similar operation is performed even in a case that any other multi-access signature resource is applied, and the sparse code or the like may be applied.

The multiple access processing unit 1043 inputs the multiple-access-processed signal to the DFT unit 1045 or the multiplexing unit 1044 depending on whether a DFTS-OFDM signal waveform or an OFDM signal waveform is used. In a case that the DFTS-OFDM signal waveform is used, the DFT unit 1045 rearranged multiple-access-processed modulation symbols output from the multiple access processing unit 1043 in parallel and then performs Discrete Fourier Transform (DFT) processing on the rearranged modulation symbols. Here, a zero symbol sequence may be added to the modulation symbols, and the DFT may then be performed to provide a signal waveform in which, instead of a CP, a zero interval is used for a time signal resulting from IFFT. A specific sequence such as Gold sequence or a Zadoff-Chu sequence may be added to the modulation symbols, and the DFT may then be performed to provide a signal waveform in which, instead of a CP, a specific pattern is used for the time signal resulting from the IFFT. In a case that the OFDM signal waveform is used, the DFT is not applied, and thus the multiple-access-processed signal is input to the multiplexing unit 1044. The controller 108 performs control using a configuration of the zero symbol sequence (the number of bits in the symbol sequence and the like) and a configuration of the specific sequence (sequence seed, sequence length, and the like), the configurations being included in the configuration information related to the grant free access.

The uplink control signal generation unit 1046 adds the CRC to the uplink control information input from the controller 108, to generate a physical uplink control channel. The uplink reference signal generation unit 1048 generates an uplink reference signal.

The multiplexing unit 1044 maps the modulation symbols of each modulated uplink physical channel of the multiple access processing unit 1043 or the DFT unit 1045, the physical uplink control channel, and the uplink reference signal to the resource elements. The multiplexing unit 1044 maps the physical uplink shared channel and the physical uplink control channel to resources allocated to each terminal apparatus.

The IFFT unit 1049 performs Inverse Fast Fourier Transform (IFFT) on the modulation symbols of each multiplexed uplink physical channel to generate OFDM symbols. The radio transmitting unit 1050 adds cyclic prefixes (CPs) to the OFDM symbols to generate a baseband digital signal. Furthermore, the radio transmitting unit 1050 converts the digital signal into an analog signal, removes excess frequency components from the analog signal by filtering, performs up-conversion to the carrier frequency, performs power amplification, and outputs the resultant signal to the transmit antenna 106 for transmission.

The receiver 112 uses the demodulation reference signal to detect the downlink physical channel transmitted from the base station apparatus 10. The receiver 112 performs detection of the downlink physical channel, based on the configuration information notified by using the control information (DCI, RRC, SIBs, or the like) from the base station apparatus. Here, the receiver 112 performs blind decoding in the search space included in the PDCCH for the candidates that are predetermined or are notified by using the control information (RRC signaling) of the higher layer. As a result of the blind decoding, the receiver 112 detects the DCI by using the CRC that is scrambled with a C-RNTI, a CS-RNTI, or another RNTI. The blind decoding may be performed by the signal detection unit 1126 in the receiver 112. Alternatively, although not illustrated in the figures, a control signal detection unit may be additionally provided, and the blind decoding may be performed by the control signal detection unit.

The radio receiving unit 1120 converts, by down-conversion, an uplink signal received through the receive antenna 110 into a baseband signal, removes unnecessary frequency components from the baseband signal, controls the amplification level in such a manner as to suitably maintain a signal level, performs orthogonal demodulation based on an in-phase component and an orthogonal component of the received signal, and converts the resulting orthogonally-demodulated analog signal into a digital signal. The radio receiving unit 1120 removes a part corresponding to the CP from the converted digital signal. The FFT unit 1121 performs Fast Fourier Transform (FFT) on the signal from which the CPs have been removed, and extracts a signal in the frequency domain.

The channel estimation unit 1122 uses the demodulation reference signal to perform channel estimation for signal detection for the downlink physical channel. The channel estimation unit 1122 receives as inputs, from the controller 108, the resources to which the demodulation reference signal is mapped and the demodulation reference signal sequence allocated to each terminal apparatus. The channel estimation unit 1122 uses the demodulation reference signal sequence to measure the channel state between the base station apparatus 10 and the terminal apparatus 20. The demultiplexing unit 1124 extracts the signal in the frequency domain input from the radio receiving unit 1120 (the signal includes signals from multiple terminal apparatuses 20). The signal detection unit 1126 uses the channel estimation result and the signal in the frequency domain input from the demultiplexing unit 1124 to detect a signal of downlink data (uplink physical channel).

The higher layer processing unit 102 acquires, from the signal detection unit 1126, the downlink data (bit sequence resulting from hard decision). The higher layer processing unit 102 performs descrambling (exclusive-OR operation) on the CRC included in the decoded downlink data for each terminal apparatus, by using the UE ID (RNTI) allocated to each terminal. In a case that no error is found in the downlink data as a result of the descrambling error detection, the higher layer processing unit 102 determines that the downlink data has been correctly received.

FIG. 6 is a diagram illustrating an example of the signal detection unit according to the present embodiment. The signal detection unit 1126 includes an equalization unit 1504, multiple access signal separation units 1506-1 to 1506-c, demodulation units 1510-1 to 1510-c, and decoding units 1512-1 to 1512-c.

The equalization unit 1504 generates an equalization weight based on the MMSE standard, from the frequency response input from the channel estimation unit 1122. Here, MRC and ZF may be used for the equalization processing. The equalization unit 1504 multiplies the equalization weight by the signal in the frequency domain input from the demultiplexing unit 1124, and extracts the signal in the frequency domain. The equalization unit 1504 outputs the equalized signal in the frequency domain to the multiple access signal separation units 1506-1 to 1506-c. c is 1 or greater, and is the number of the signals received in the same subframe, the same slot, or the same OFDM symbol, such as the PUSCH and the PUCCH. Reception of other downlink channels may be reception at the same timing.

The multiple access signal separation units 1506-1 to 1506-c separate the signal multiplexed by the multi-access signature resource from the signal in the time domain (multiple access signal separation processing). For example, in a case that code spreading is used as a multi-access signature resource, each of the multiple access signal separation units 1506-1 to 1506-c performs inverse spreading processing by using a used spreading code sequence. Note that, in a case that interleaving is applied as a multi-access signature resource, de-interleaving is performed on the signal in the time domain (deinterleaving unit).

The demodulation units 1510-1 to 1510-c receive as an input, from the controller 108, pre-notified or predetermined information about the modulation scheme. Based on the information about the modulation scheme, the demodulation units 1510-1 to 1510-c perform demodulation processing on the separated multiple access signal, and output a Log Likelihood Ratio (LLR) of the bit sequence.

The decoding units 1512-1 to 1512-c receive as an input, from the controller 108, pre-notified or predetermined information about the coding rate. The decoding units 1512-1 to 1512-c perform decoding processing on the LLR sequences output from the demodulation units 1510-1 to 1510-c. In order to perform cancellation processing such as a Successive Interference Canceller (SIC) or turbo equalization, the decoding units 1512-1 to 1512-c may perform the cancellation processing by generating a replica from external LLR or post LLR output from the decoding units. A difference between the external LLR and the post LLR is whether to subtract, from the decoded LLR, the pre LLR input to each of the decoding units 1512-1 to 1512-c.

The transmission power control of the uplink data (PUSCH) is calculated according to: P_{PUSCH,f,c}(i, j, q_{d}, l)=min{P_{CMAX,f,c}(i), P_{O_PUSCH,f,c}(j)+10 log₁₀(2 μM_{PUSCH_RB,f,c}(i))+α_{f,c}(j)·PL_{f,c}(q_{d})+Δ_{TF,f,c}(i)+f_{f,c}(i, l)}. Here, the function of min is to select the smaller value in { }. P_{CMAX,f,c}(i) represents allowable maximum transmit power of the terminal apparatus in the i-th subframe of a carrier f and a serving cell c. P_{O_PUSCH,f,c}(j) represents nominal target received power per RB in scheduling j in the carrier f and the serving cell c configured by using a higher layer (RRC). j represents a value that depends on a type of scheduling and a transmit signal. j=0 represents the RACH. j=1 represents the SPS/grant free access. j=2 to J−1 is specified by using DCI (for example, an SRS Resource Indicator (SRI) field) after multiple values are configured by using a higher layer (RRC) for the dynamic scheduling. α_{f,c}(j) represents a parameter of fractional transmission power control in the carrier f and the serving cell c. PL_{f,c}(q_{d}) represents a path loss in a resource q_{d} of a reference signal for path loss measurement of the serving cell c. Δ_{TF,f,c}(i) represents a parameter of a modulation order of the i-th subframe in the carrier f and the serving cell c. f_{f,c}(i, l) represents a parameter notified from the base station apparatus to the terminal apparatus in order to perform closed loop control in the carrier f and the serving cell c. l represents a variable for enabling multiple times of closed loop control. For example, usually, l=1. In a case that l={1, 2} is configured by using a higher layer (RRC) and a TPC command of any one of l=1 and l=2 is transmitted, reflection to only one of those is possible. Regarding appropriate use of l=1 and l=2, by configuring the value of l used in the SPS/grant free access, the other may be used for the dynamic scheduling. P_{O_PUSCH,f,c}(j) used for calculation of the transmit power is determined by the sum of P_{O_NOMINAL_PUSCH,f,c}(j) and P_{O_UE_PUSCH,f,c}(j). In a case that j=0, P_{O_NOMINAL_PUSCH,f,c}(j) is determined by the sum of P_{O_PRE} notified by using a higher layer (RRC) and Δ_{PREAMBLE_Msg3}, and in a case that j=1, 2, configuration is performed by using a higher layer (RRC), and multiple values for the SPS/grant free access and the dynamic scheduling are configured. In a case that j=0, P_{O_UE_PUSCH,c}(j) is 0, and a value of the case that j=1, 2 is notified by using a higher layer (RRC), and multiple values for the SPS/grant free access and the dynamic scheduling are configured.

P_{CMAX,f,c}(i) is configured depending on capability of a Power Amplifier (PA) included in the terminal apparatus between P_{CMAX_L,c}(i) that is determined based on Maximum Power Reduction (MPR), Additional-MPR (A-MPR), and Power Management-MPR (P-MPR) and P_{CMAX_H,c}(i) that is determined based on P_{EMAX,c} and P_{PowerClass}.

Only P_{O_PUSCH,f,c}(j) representing the target received power and α_{f,c}(j) representing the parameter of the fractional transmission power control varying depending on a type of scheduling can be specified by using DCI and can be dynamically changed. Regarding which P_{O_PUSCH,f,c}(j) of multiple target received power is used in the dynamic scheduling, because a field of the SRI is not present in the DCI format 0_0 for fallback in a case of specification using the SRI of the DCI, a field of the SRI of DCI format 0_1 supporting multi-antenna transmission is used.

The transmission power control of the uplink control information (PUCCH) is calculated according to: P_{PUCCH,f,c}(i, qᵤ, q_{d}, l)=min{P_{CMAX,f,c}(i), P_{O_PUCCH,f,c}(qᵤ)+PL_{f,c}(q_{d})+Δ_{F_PUCCH}(F)+Δ_{TF,f,c}(i)+g_{f,c}(i, l)}. Here, the function of min is to select the smaller value in { }. P_{CMAX,f,c}(i) represents allowable maximum transmit power of the terminal apparatus in the i-th subframe of a carrier f and a serving cell c. P_{O_PUCCH,f,c}(qᵤ) represents nominal target received power of qᵤ in the carrier f and the serving cell c configured by using a higher layer (RRC). qᵤ represents an index of the target received power of the PUCCH and qᵤ=0 to Qᵤ−1. Qᵤ is configured by using a higher layer (RRC). PL_{f,c}(q_{d}) represents a path loss in a resource q_{d} of a reference signal for path loss measurement of the serving cell c. Δ_{F_PUCCH}(F) represents a value of each PUCCH format configured by using a higher layer (RRC). Δ_{TF,f,c}(i) represents a parameter of a modulation order of the i-th subframe in the carrier f and the serving cell c. g_{f,c}(i, l) represents a parameter notified from the base station apparatus to the terminal apparatus in order to perform closed loop control in the carrier f and the serving cell c. l represents a variable for enabling multiple times of closed loop control. For example, usually, l=1. In a case that l={1, 2} is configured by using a higher layer (RRC) and a TPC command of any one of l=1 and l=2 is transmitted, reflection to only one of those is possible. Regarding appropriate use of l=1 and l=2, by configuring the value of l used in the SPS/grant free access, the other may be used for the dynamic scheduling.

In the data transmission of URLLC, not only reliability of data transmission of the PUSCH but also reliability of the DCI format transmitted on the PDCCH allowing data transmission is important. Regarding this, in a case that an error rate of the DCI format is represented by P_{CONT} and an error rate of data is represented by P_{DATA}, the following expression is obtained: uplink error rate which also includes a detection rate of the DCI format P_{Total}=1−(1−P_{CONT})−(1−P_{DATA}). In other words, it is necessary that reliability (error rate) that requires P_{Total} be achieved. For this reason, not only reliability (P DATA) of the uplink data transmission but also reliability (P_{CONT}) of detection of the DCI format is also important. Here, regarding the DCI format, in LTE and NR, the DCI format is mapped to predetermined resource elements (search space). Thus, in a case that the number of resource elements (aggregation level) is fixed, a DCI format having a large payload size is transmitted with a high coding rate as compared to a DCI format having a small payload size, which makes it difficult to achieve high reliability.

Thus, the compact DCI (Small Size DCI) having a reduced payload size of DCI format 0_0/0_1 for uplink data transmission, hereinafter, a compact DCI for uplink data transmission, is referred to as DCI format 0_c. A compact DCI (Small Size DCI) having a reduced payload size of DCI format 1_0/1_1 for downlink data transmission, hereinafter, a compact DCI for downlink data transmission, is referred to as DCI format 1_c. As an example, DCI format 0_c and DCI format 1_c may be implemented by reducing the number of bits of each of the fields of DCI format 0_0 and DCI format 1_0 or by omitting some of the fields and notifying by using higher layer control (RRC signaling) or using a predetermined value. Specifically, regarding DCI format 0_c and DCI format 1_c, the number of bits may be reduced by setting a limit on the start position of resource allocation in the frequency domain or the number of RBs (reducing values that can be specified), or the number of bits may be reduced by setting a limit on at least some of the OFDM symbol position of the start of resource allocation in the time domain, the number of OFDM symbols used for data transmission, and the number of slots from reception of the DCI format to data transmission (reducing values that can be specified). Regarding DCI format 0_c and DCI format 1_c, the number of entries of the MCS that can be specified may be reduced (a modulation order and an MCS with a high coding rate cannot be specified, or entries assigned even numbers or odd numbers cannot be specified). For example, regarding DCI format 0_c and DCI format 1_c, the MCS may be of 3 bits or 4 bits, and regarding DCI format 0_0/0_1 and DCI format 1_0/1_1, the MCS may be of 5 bits. Regarding DCI format 0_c and DCI format 1_c, the number of bits may be reduced by setting a limit on the HARQ process number that can be specified.

The data transmission of URLLC is traffic that requires not only high reliability but also low latency. Thus, it is preferable that the SPS/grant free access that does not require the RACH and the SR being a resource request before data transmission and reception of the UL Grant using the DCI format can be utilized. Thus, the grant free access (Configured Uplink Grant, uplink grant being configured) may be configured for the data transmission of URLLC, and dynamic scheduling (uplink grant addressed to the C-RNTI) may be configured for the data transmission of other than URLLC. However, in a case that the uplink grant addressed to the C-RNTI of the dynamic scheduling and Configured Uplink Grant (uplink grant being configured) of the SPS/grant free access overlap in the time domain in the same component carrier (in the same serving cell), only the uplink grant addressed to the C-RNTI of the dynamic scheduling may be used regardless of a requirement of data. (The uplink grant addressed to the C-RNTI of the dynamic scheduling overrides the Configured Uplink Grant.)

FIG. 7 illustrates an example of notification of the uplink grant according to related art. In the figure, as described above, activation of the Configured Uplink Grant (uplink grant being configured) of the SPS/grant free access using the DCI format is notified on the PDCCH of slot x, and the uplink grant addressed to the C-RNTI using the DCI format is notified on the PDCCH of slot x+1. In this case, the uplink grants overlap (overlap in the time domain) in uplink slots x+2 and x+3, and thus only the uplink grant addressed to the C-RNTI is used.

The present embodiment illustrates a method of switching the uplink grant to be used, out of the uplink grant addressed to the C-RNTI of the dynamic scheduling and the Configured Uplink Grant (uplink grant being configured) of the SPS/grant free access. In the present embodiment, the uplink grant to be used is switched depending on a type of the DCI format used for notification of the uplink grant (dynamic scheduling) addressed to the C-RNTI and the DCI format used for notification of the Configured Uplink Grant (uplink grant being configured). First, in the uplink grant addressed to the C-RNTI, notification using DCI format 0_0/0_1 and DCI format 0_c being compact DCI can be performed, and DCI format 0_c is used for the data transmission that requires high reliability. Next, in the Configured Uplink Grant (uplink grant being configured) of SPS type 2, DCI format 0_0/0_1 and DCI format 0_c being compact DCI can be used for activation, and DCI format 0_c is used for activation in the data transmission that requires high reliability.

The terminal apparatus detects the DCI format by performing blind decoding on the predetermined search space for the PDCCH. In a case that blind decoding of one or both of DCI format 0_c and DCI format 1_c being compact DCI is configured (set up) by using higher layer control information (RRC signaling), the terminal apparatus performs blind decoding of DCI format 0_0/0_1 and DCI format 0_c in a case of the uplink configuration, and performs blind decoding of DCI format 1_0/1_1 and DCI format 1_c in a case of the downlink configuration.

FIG. 8 illustrates an example of notification of the uplink grant according to the first embodiment. The figure illustrates an example in which activation of the uplink grant (SPS/grant free access Type 2) configured by using Compact DCI on the PDCCH of slot x is notified, and the configured uplink grant is present in each slot of slot x+1 and thereafter (radio resource allocation with a period of one slot). Next, in slot x+1, the uplink grant addressed to the C-RNTI is notified by using DCI format 0_0/0_1, and the uplink grant addressed to the C-RNTI is configured in slot x+2 and slot x+3. In this case, in slot x+2 and slot x+3, the uplink grant addressed to the C-RNTI and the uplink grant configured by using Compact DCI overlap (overlap in at least some of the OFDM symbols) in the time domain. In this case, in the data transmission, only the uplink grant configured by using Compact DCI may be used. This means that only the uplink grant configured by using Compact DCI is used regardless of a type of scheduling such as dynamic scheduling and SPS.

In a case that the uplink grant to be used is determined by using the DCI format, traffic (buffer status) of the terminal apparatus may also be taken into consideration. Regarding this, in the grant free access/SPS, data transmission is performed by using the configured uplink grant only in a case that there is data to be transmitted, and in other cases, data transmission is not performed using the configured uplink grant. Here, a case that there is no data to be transmitted may mean no reaching of a transport block (TB) transmitted in a resource allocated for the grant free access/SPS (uplink transmission without grant) by the higher layer.

As in FIG. 8, in a case that the uplink grant addressed to the C-RNTI and the uplink grant configured by using Compact DCI overlap in the time domain, traffic for the uplink grant addressed to the C-RNTI is provided, and traffic for the uplink grant configured by using Compact DCI is not provided, the uplink grant addressed to the C-RNTI may be used. As in FIG. 8, in a case that the uplink grant addressed to the C-RNTI and the uplink grant configured by using Compact DCI overlap in the time domain and traffic for the uplink grant configured by using Compact DCI is provided, the uplink grant configured by using Compact DCI may be used regardless of the presence or absence of traffic for the uplink grant addressed to the C-RNTI.

On the other hand, with reference to FIG. 7, description is given of a case that activation of the uplink grant (SPS/grant free access Type 2) configured by using DCI format 0_0/0_1 on the PDCCH of slot x is notified, and the configured uplink grant is present in each slot of slot x+1 and thereafter (radio resource allocation with a period of one slot). In this case, in slot x+1, the uplink grant addressed to the C-RNTI is notified by using DCI format 0_0/0_1, and in slot x+2 and slot x+3, the uplink grant addressed to the C-RNTI is configured. As a result, in slot x+2 and slot x+3, the uplink grant addressed to the C-RNTI and the uplink grant configured by using DCI format 0_0/0_1 overlap (overlap in at least some of the OFDM symbols) in the time domain. Both of the uplink grant addressed to the C-RNTI and the configured uplink grant are notified by using DCI format 0_0/0_1, and the same DCI format is thus used. In this case, the uplink grant to be used may be determined depending on a type of scheduling, and the uplink grant addressed to the C-RNTI may override the configured uplink grant.

As in FIG. 7, in a case that the uplink grant addressed to the C-RNTI and the uplink grant configured by using DCI format 0_0/0_1 overlap (overlap in at least some of the OFDM symbols) in the time domain, traffic for the uplink grant configured by using DCI format 0_0/0_1 may be provided, and in a case that traffic for the uplink grant addressed to the C-RNTI is not provided, the uplink grant configured by using DCI format 0_0/0_1 may be used.

Here, traffic provided for the uplink grant may be determined by Quality of Service (QoS), or may be determined by, for example, information of a QoS Class Indicator (QCI).

Note that, in the present embodiment, the uplink grant to be used is determined based on the DCI format. However, the uplink grant to be used may be determined based on the search space in which the DCI format is detected, or the uplink grant to be used may be determined based on both of the DCI format and the search space. For example, only the uplink grant of the DCI format detected in the common search space may be used, and the uplink grant of the DCI format detected in the user-specific search space may not be used.

Note that, in the description of the present embodiment, the uplink grants of DCI format 0_0 and DCI format 0_1 are of the same type. However, the uplink grants of DCI format 0_0 and DCI format 0_1 may be of different types. For example, in order of preferential use of the uplink grant, the highest priority may be given to DCI format 0_c, the second highest priority may be given to DCI format 0_0, and the lowest priority may be given to DCI format 0_1. The higher priority may be given as the payload size of the DCI format is smaller. Here, regarding the uplink grants that overlap in the time domain, only the uplink grant given high priority may be used. In the following description, in the sense of “being prioritized”, only the uplink grant given the highest priority may be used, or only multiple uplink grants given higher priority may be used.

Note that, in the present embodiment, a case of a single serving cell (single component carrier) is described. However, the present invention may be applied to carrier aggregation. In a case of carrier aggregation, priority may vary depending on a type of the serving cell in which the DCI format is detected, in addition to the priority of the DCI format described above. For example, in a case that DCI formats given the same priority are detected in multiple serving cells and multiple uplink grants overlap in the time domain, the uplink grant of the DCI format detected in a Pcell may be given the highest priority, the uplink grant of the DCI format detected in a PScell may be given the second highest priority, and the uplink grant of the DCI format detected in an Scell may be given the lowest priority. In a case of Dual Connectivity (DC), the uplink grant of the DCI format detected in the serving cell of a PCG may be prioritized over the uplink grant of the DCI format detected in the serving cell of an SCG. In a case that SUL is available, the uplink grant of the DCI format detected in an SUL carrier may be prioritized over the uplink grant of the DCI format detected in a carrier other than the SUL carrier. The SUL uses a frequency and thus has wide coverage, and easily satisfies requirements of high reliability and low latency. The SUL may be applied also in a case that the BWP is configured, and the uplink grant of the DCI format detected in the BWP with a wide subcarrier spacing may be prioritized over the uplink grant of the DCI format detected in the BWP with a narrow subcarrier spacing.

Note that the description of the present embodiment is mainly directed to the uplink grant. However, the present invention may be applied to the downlink grant of SPS and addressed to the C-RNTI.

In the present embodiment, depending on whether or not the uplink grant is an uplink grant notified by using the DCI format satisfying high reliability, priority of a case that multiple uplink grants overlap in the time domain is determined. As a result, by appropriately using the DCI format to be used for notification of the uplink grant, the base station apparatus can configure the uplink data transmission to be prioritized. As a result, requirements of data that requires high reliability and low latency can be satisfied.

### Second Embodiment

In order to implement high reliability, the present embodiment will describe a determination method of priority of allocation of transmit power in a case that multiple uplink grants overlap in the time domain in a case that carrier aggregation is used. The communication system according to the present embodiment includes the base station apparatus 10 and the terminal apparatus 20 described with reference to FIG. 3, FIG. 4, FIG. 5, and FIG. 6. Differences from/additions to the first embodiment will be mainly described below.

The previous embodiment has described an example in which multiple uplink grants are configured in one serving cell and overlap in the time domain. The present embodiment, however, will describe a case of carrier aggregation. In carrier aggregation, data transmission and/or reception can be performed by using multiple component carriers (serving cells). The terminal apparatus performs detection of the uplink grant using DCI format 0_0/0_1 and the downlink grant using DCI format 1_0/1_1 by performing blind decoding in each of the component carriers. Here, even in a case that the uplink grants are detected in multiple component carriers and the multiple uplink grants overlap in the time domain, data transmission based on all of the uplink grants can be performed on the condition that the terminal apparatus supports simultaneous transmission. Note that in a case that the terminal apparatus has a configuration of the maximum transmit power P_{CMAX,f,c}(i) and total transmit power in the multiple component carriers that require simultaneous data transmission exceeds the maximum transmit power P_{CMAX,f,c}(i), transmit power equal to or less than the maximum transmit power P_{CMAX,f,c}(i) is used by adjusting the total transmit power.

In a case that reliability and delay time required in data to be transmitted in each of the component carriers are the same and the total transmit power of the multiple component carriers exceeds the maximum transmit power, similarly to the related art, a certain ratio of the transmit power may be reduced in the multiple component carriers, and data transmission not exceeding the maximum transmit power may be performed. However, in a case that data transmission of URLLC that requires high reliability and low latency is performed in the first component carrier and data transmission of eMBB with relatively looser requirements of high reliability and low latency is performed in the second component carrier, reduction of the transmit power at a certain ratio so as not to exceed the maximum transmit power inhibits satisfaction of the requirements of high reliability or low latency.

In view of this, the present embodiment will describe an allocation method of the transmit power of a case that, in carrier aggregation, the uplink grants of data transmission of URLLC that requires high reliability and low latency and data transmission of eMBB with relatively looser requirements of high reliability and low latency are received in multiple component carriers, these uplink grants overlap in the time domain, and total transmit power of the multiple component carriers exceeds the maximum transmit power of the terminal apparatus. First, the uplink grant of the data transmission of URLLC is notified by using DCI format 0_c, and the uplink grant of the data transmission of eMBB is notified by using DCI format 0_0/0_1. Here, in a case that DCI format 0_c is detected in the first component carrier, DCI format 0_0/0_1 is detected in the second component carrier, the uplink grants of DCI format 0_c and DCI format 0_0/0_1 overlap in the time domain, and total transmit power of uplink data transmission of the two component carriers exceeds the maximum transmit power of the terminal apparatus, the terminal apparatus prioritizes allocation of the transmit power for the data transmission of the uplink grant notified by using DCI format 0_c. In other words, in a case that the transmit power of the data transmission based on DCI format 0_c is represented by P_{PUSCH,f,c}(0_c) according to the expression of the transmission power control, the transmit power of the data transmission based on DCI format 0_0/0_1 is represented by P_{PUSCH,f,c}(0_0/0_1) according to the expression of the transmission power control, and the maximum transmit power of the terminal apparatus is represented by P_{CMAX,f,c}, the transmit power to be used for the data transmission based on DCI format 0_c is P_{PUSCH,f,c}(0_c), and the transmit power of the data transmission based on DCI format 0_0/0_1 is P_{CMAX,f,c}−P_{PUSCH,f,c}(0_c), that is, excessive transmit power of P_{PUSCH,f,c}(0_c) after the transmit power allocation. Note that P_{PUSCH,f,c}(0_c)≤P_{CMAX,f,c} and P_{PUSCH,f,c}(0_0/0_1)≤P_{CMAX,f,c} are satisfied (power does not exceed the maximum transmit power).

Note that, in the present embodiment, in carrier aggregation, in a case that transmissions of multiple pieces of data (PUSCHs) are performed and the total transmit power exceeds the maximum transmit power P_{CMAX,f,c} of the terminal apparatus, the transmit power is preferentially allocated to any of the data transmissions. Here, to preferentially allocate the transmit power may mean that the terminal apparatus performs scaling of P₂ so that a state of the expression wP2≤P_{CMAX,f,c}−P₁ is satisfied, where P₁ represents transmit power of data to which the transmit power is preferentially allocated and P₂ represents transmit power of data to which the transmit power is not preferentially allocated. Here, w is used by the terminal apparatus for scaling so that its power does not exceed the total transmit power, and 0≤w≤1 is satisfied. w may be calculated for each transmission period i, and the OFDM symbol may be used as the transmission period i, the slot may be used as the transmission period i, or multiple OFDMs used for data transmission may be used as one unit. The description above describes a case that P₁ and P₂ are both data transmissions. However, the present invention may be applied to a case that any one of P₁ and P₂ is uplink control information (PUCCH), or may be applied to a case that both of P₁ and P₂ are uplink control information. The present invention may be applied to a case that any one of P₁ and P₂ is a Sounding Reference Signal (SRS), or may be applied to a case that both of P₁ and P₂ are SRSs. The present invention may be applied to a case that any one of P₁ and P₂ is RACH transmission, or may be applied to a case that both of P₁ and P₂ are RACH transmissions. In the following description, an example of the method of preferentially allocating the transmit power described above is hereinafter described as the expression “to preferentially allocate transmit power”. However, other methods of preferentially allocating the transmit power may be applied.

Note that, in a case that both of P₁ and P₂ are uplink control information (PUCCH), the uplink control information at least includes information of the ACK/NACK for downlink data, and the sum of P₁ and P₂ calculated according to the expression of the transmission power control exceeds the maximum transmit power P_{CMAX,f,c} of the terminal apparatus, a method in which the terminal apparatus determines 0≤w≤1 that satisfies w (P₁+P₂)≤P_{CMAX,f,c} for uniformly scaling the whole and a method of preferentially allocating either transmit power are conceivable. Here, whether or not priority is set may be determined depending on a type of the DCI format used for notification of the downlink grant for the downlink data transmission. For example, in a case that the transmit power of the ACK/NACK of downlink data reception (PDSCH) based on the downlink grant notified by using DCI format 1_c in the first component carrier (the Pcell or the PSCell) is represented by P₁ and the transmit power of the ACK/NACK of the downlink data reception (PDSCH) based on the downlink grant notified by using DCI format 1_0/1_1 in the second component carrier (the Pcell or the PSCell) is represented by P₂, P₁ may be preferentially allocated, or only the prioritized ACK/NACK may be transmitted and the unprioritized ACK/NACK may not be transmitted (may be dropped). In a case that the ACK/NACK of the downlink data reception based on the downlink grant notified by using DCI format 1_0/1_1 in the first and second component carriers is transmitted, w (P₁+P₂)≤P_{CMAX,f,c} for uniformly scaling the whole may be applied. In a case that the ACK/NACK of downlink data reception based on the downlink grant notified by using DCI format 1_c in the first and second component carriers is transmitted, w (P₁+P₂)≤P_{CMAX,f,c} for uniformly scaling the whole may be applied.

Here, in a case that the first component carrier detects DCI format 0_c in the Pcell, the second component carrier detects DCI format 0_0/0_1 in the Scell, multiple data transmissions (uplink grants) overlap in the time domain, and total transmit power of the data transmission based on DCI format 0_c and the data transmission based on DCI format 0_0/0_1 exceeds the maximum transmit power of the terminal apparatus, allocation of the transmit power to the data transmission based on DCI format 0_c is prioritized as described above.

Next, in a case that the first component carrier detects DCI format 0_0/0_1 in the Pcell, the second component carrier detects DCI format 0_c in the Scell, multiple data transmissions (uplink grants) overlap in the time domain, and total transmit power of the data transmission based on DCI format 0_0/0_1 and the data transmission based on DCI format 0_c exceeds the maximum transmit power of the terminal apparatus, allocation of the transmit power to the data transmission based on DCI format 0_c of the Scell is prioritized.

In a case that the first component carrier detects DCI format 0_0/0_1 in the Pcell, the second component carrier detects DCI format 0_0/0_1 in the Scell, multiple data transmissions (uplink grants) overlap in the time domain, and total transmit power of the data transmission based on DCI format 0_0/0_1 of the Pcell and the data transmission based on DCI format 0_0/0_1 of the Scell exceeds the maximum transmit power of the terminal apparatus, allocation of the transmit power to the data transmission based on DCI format 0_0/0_1 of the Pcell is prioritized.

In a case that the first component carrier detects DCI format 0_c in the Pcell, the second component carrier detects DCI format 0_c in the Scell, multiple data transmissions (uplink grants) overlap in the time domain, and total transmit power of the data transmission based on DCI format 0_c of the Pcell and the data transmission based on DCI format 0_c of the Scell exceeds the maximum transmit power of the terminal apparatus, allocation of the transmit power to the data transmission based on DCI format 0_c of the Pcell may be prioritized, or the transmit power of the data transmission based on DCI format 0_c of the Pcell and the Scell may be reduced at a certain ratio so that the data transmission of the Pcell and the Scell may be simultaneously performed with the maximum transmit power or lower.

In a case that the first component carrier detects DCI format 0_c in the Pcell, the second component carrier detects DCI format 0_0/0_1 in the PScell, multiple data transmissions (uplink grants) overlap in the time domain, and total transmit power of the data transmission based on DCI format 0_c and the data transmission based on DCI format 0_0/0_1 exceeds the maximum transmit power of the terminal apparatus, as described above, allocation of the transmit power to the data transmission based on DCI format 0_c is prioritized.

Next, in a case that the first component carrier detects DCI format 0_0/0_1 in the Pcell, the second component carrier detects DCI format 0_c in the PScell, multiple data transmissions (uplink grants) overlap in the time domain, and total transmit power of the data transmission based on DCI format 0_0/0_1 and the data transmission based on DCI format 0_c exceeds the maximum transmit power of the terminal apparatus, allocation of the transmit power to the data transmission based on DCI format 0_c of the PScell is prioritized.

In a case that the first component carrier detects DCI format 0_0/0_1 in the Pcell, the second component carrier detects DCI format 0_0/0_1 in the PScell, multiple data transmissions (uplink grants) overlap in the time domain, and total transmit power of the data transmission based on DCI format 0_0/0_1 of the Pcell and the data transmission based on DCI format 0_0/0_1 of the PScell exceeds the maximum transmit power of the terminal apparatus, allocation of the transmit power to the data transmission based on DCI format 0_0/0_1 of the Pcell is prioritized.

In a case that the first component carrier detects DCI format 0_c in the Pcell, the second component carrier detects DCI format 0_c in the PScell, multiple data transmissions (uplink grants) overlap in the time domain, and total transmit power of the data transmission based on DCI format 0_c of the Pcell and the data transmission based on DCI format 0_c of the PScell exceeds the maximum transmit power of the terminal apparatus, allocation of the transmit power to the data transmission based on DCI format 0_c of the Pcell may be prioritized, or the transmit power of the data transmission based on DCI format 0_c of the Pcell and the PScell may be reduced at a certain ratio so that the data transmission of the Pcell and the PScell may be simultaneously performed with the maximum transmit power or lower.

In a case that the first component carrier detects DCI format 0_c in the PScell, the second component carrier detects DCI format 0_0/0_1 in the Scell, multiple data transmissions (uplink grants) overlap in the time domain, and total transmit power of the data transmission based on DCI format 0_c and the data transmission based on DCI format 0_0/0_1 exceeds the maximum transmit power of the terminal apparatus, as described above, allocation of the transmit power to the data transmission based on DCI format 0_c is prioritized.

Next, in a case that the first component carrier detects DCI format 0_0/0_1 in the PScell, the second component carrier detects DCI format 0_c in the Scell, multiple data transmissions (uplink grants) overlap in the time domain, and total transmit power of the data transmission based on DCI format 0_0/0_1 and the data transmission based on DCI format 0_c exceeds the maximum transmit power of the terminal apparatus, allocation of the transmit power to the data transmission based on DCI format 0_c of the Scell is prioritized.

In a case that the first component carrier detects DCI format 0_0/0_1 in the PScell, the second component carrier detects DCI format 0_0/0_1 in the Scell, multiple data transmissions (uplink grants) overlap in the time domain, and total transmit power of the data transmission based on DCI format 0_0/0_1 of the PScell and the data transmission based on DCI format 0_0/0_1 of the Scell exceeds the maximum transmit power of the terminal apparatus, allocation of the transmit power to the data transmission based on DCI format 0_0/0_1 of the PScell is prioritized.

In a case that the first component carrier detects DCI format 0_c in the PScell, the second component carrier detects DCI format 0_c in the Scell, multiple data transmissions (uplink grants) overlap in the time domain, and total transmit power of the data transmission based on DCI format 0_c of the PScell and the data transmission based on DCI format 0_c of the Scell exceeds the maximum transmit power of the terminal apparatus, allocation of the transmit power to the data transmission based on DCI format 0_c of the PScell may be prioritized, or the transmit power of the data transmission based on DCI format 0_c of the PScell and the Scell may be reduced at a certain ratio so that the data transmission of the PScell and the Scell may be simultaneously performed with the maximum transmit power or lower.

Note that priority order of allocation of the transmit power in a case of detection of multiple uplink grants in the Pcell and the Scell, the Pcell and the PScell, and the PScell and the Scell has been described. However, the present invention may also be applied to the MCS and the SCG, and the allocation of the transmit power described above may be performed with the Pcell being a serving cell of the MCG and the PScell being a serving cell of the SCG.

Note that the present embodiment has given description of, in carrier aggregation, in a case that multiple uplink grants overlap in the time domain, the uplink grant (data transmission) to which the transmit power is preferentially allocated and the uplink grant (data transmission) to which the remaining transmit power is allocated. However, only the data transmission of the uplink grant (data transmission) to which the transmit power is preferentially allocated may be performed, and the uplink grant (data transmission) to which the remaining transmit power is allocated may not be transmitted (may be dropped).

Note that the present embodiment has given description of, in carrier aggregation, in a case that multiple uplink grants overlap in the time domain, the uplink grant (data transmission) to which the transmit power is preferentially allocated and the uplink grant (data transmission) to which the remaining transmit power is allocated. However, in a case that the remaining transmit power falls below a prescribed threshold (minimum transmit power), the uplink grant (data transmission) to which the remaining transmit power is allocated may not be transmitted (may be dropped). The prescribed threshold may be predetermined, or may be notified by using higher layer control information (RRC signaling).

Note that the present embodiment has described a case of two component carriers in carrier aggregation. However, the present invention may be applied to three or more component carriers, or a difference between the maximum transmit power of the terminal apparatus and the transmit power of the uplink grant (data transmission) to which one or multiple transmit power is preferentially allocated may be calculated and the remaining transmit power may be allocated to the unprioritized uplink grant (data transmission).

Note that the present embodiment has described a case that the dynamic scheduling (scheduled access) is used for multiple uplink grants. However, DCI format 0_c of the example of FIG. 8 may be the configured uplink grant obtained through the activation of the SPS/grant free access, and the dynamic scheduling (uplink grant addressed to the C-RNTI) may be used for DCI format 0_0/0_1.

Note that, in a case that the periodic configured uplink grant obtained through the activation of the SPS/grant free access using DCI format 0_c is notified in the first component carrier, the periodic configured uplink grant obtained through the activation of the SPS/grant free access using DCI format 0_0/0_0 is notified in the second component carrier, the uplink grant configured using DCI format 0_c and the uplink grant configured using DCI format 0_0/0_0 overlap in the time domain, and total data transmission based on the multiple uplink grants exceeds the maximum transmit power of the terminal apparatus, the transmit power may be preferentially allocated to the data transmission of the uplink grant configured using DCI format 0_c and the remaining transmit power may be allocated to the data transmission of the uplink grant configured using DCI format 0_0/0_0, or only the data transmission of the uplink grant configured using DCI format 0_c may be performed.

Note that, in a case that the periodic configured uplink grant obtained through the activation of the SPS/grant free access using DCI format 0_c is notified in the first component carrier, the uplink grant of the dynamic scheduling using DCI format 0_0/0_0 is notified in the second component carrier, the uplink grant configured using DCI format 0_c and the uplink grant using DCI format 0_0/0_0 overlap in the time domain, and total data transmission based on the multiple uplink grants exceeds the maximum transmit power of the terminal apparatus, the transmit power may be preferentially allocated to the data transmission of the uplink grant configured using DCI format 0_c and the remaining transmit power may be allocated to the data transmission of the uplink grant using DCI format 0_0/0_0, or only the data transmission of the uplink grant configured using DCI format 0_c may be performed.

Note that, in a case that the uplink grant of the dynamic scheduling using DCI format 0_c is notified in the first component carrier, the uplink grant of the dynamic scheduling using DCI format 0_0/0_0 is notified in the second component carrier, the uplink grant using DCI format 0_c the uplink grant using DCI format 0_0/0_0 overlap in the time domain, and total data transmission based on the multiple uplink grants exceeds the maximum transmit power of the terminal apparatus, the transmit power may be preferentially allocated to the data transmission of the uplink grant using DCI format 0_c and the remaining transmit power may be allocated to the data transmission of the uplink grant using DCI format 0_0/0_0, or only the data transmission of the uplink grant configured using DCI format 0_c may be performed.

In the present embodiment, depending on whether or not the uplink grant is the uplink grant notified by using the DCI format satisfying high reliability, priority of the allocation of the transmit power in a case that multiple uplink grants overlap in the time domain is determined. As a result, by appropriately using the DCI format to be used for notification of the uplink grant, the base station apparatus can configure the uplink data transmission whose allocation of the transmit power is prioritized. As a result, requirements of data that requires high reliability and low latency can be satisfied.

### Third Embodiment

In order to implement high reliability, the present embodiment will describe a determination method of priority of allocation of transmit power in a case that multiple uplink grants overlap in the time domain in a case that carrier aggregation is used and the BWP is configured for each component carrier (serving cell). The communication system according to the present embodiment includes the base station apparatus 10 and the terminal apparatus 20 described with reference to FIG. 3, FIG. 4, FIG. 5, and FIG. 6. Differences from/additions to the first embodiment will be mainly described below.

The present embodiment will describe an allocation method of the transmit power in a case that the uplink grants of the data transmission of URLLC that requires high reliability and low latency in multiple component carriers and the data transmission of eMBB with relatively looser requirements of high reliability and low latency are received, these uplink grants overlap in the time domain, and total transmit power of the multiple component carriers (BWPs) exceeds the maximum transmit power of the terminal apparatus, in a case that carrier aggregation is used and the BWP is configured for each component carrier (serving cell). First, the uplink grant of the data transmission of URLLC is notified by using DCI format 0_c, and the uplink grant of the data transmission of eMBB is notified by using DCI format 0_0/0_1. Here, in a case that DCI format 0_c is detected in the first component carrier (hereinafter the first BWP), DCI format 0_0/0_1 is detected in the second component carrier (hereinafter the second BWP), the uplink grants of DCI format 0_c and DCI format 0_0/0_1 overlap in the time domain, and total transmit power of the uplink data transmissions of the two component carriers (BWPs) exceeds the maximum transmit power of the terminal apparatus, the terminal apparatus prioritizes allocation of the transmit power to the data transmission of the uplink grant notified by using DCI format 0_c. In other words, in a case that the transmit power of the data transmission based on DCI format 0_c is represented by P_{PUSCH,f,c}(0_c) according to the expression of the transmission power control, the transmit power of the data transmission based on DCI format 0_0/0_1 is represented by P_{PUSCH,f,c} (0_0/0_1) according to the expression of the transmission power control, and the maximum transmit power of the terminal apparatus is represented by P_{CMAX,f,c}, the transmit power to be used for the data transmission based on DCI format 0_c is P_{PUSCH,f,c}(0_c), and the transmit power of the data transmission based on DCI format 0_0/0_1 is P_{CMAX,f,c}−P_{PUSCH,f,c}(0_c), that is, excessive transmit power of P_{PUSCH,f,c}(0_c) after the transmit power allocation. Note that P_{PUSCH,f,c}(0_c)≤P_{CMAX,f,c} and P_{PUSCH,f,c} (0_0/0_1)≤P_{CMAX,f,c} are satisfied (power does not exceed the maximum transmit power).

Here, in a case that DCI format 0_c is detected in the first BWP, DCI format 0_c is detected in the second BWP, the uplink grants of the multiple DCI formats 0_c overlap in the time domain, and total transmit power of the uplink data transmissions of the two BWPs exceeds the maximum transmit power of the terminal apparatus, the transmit power may be preferentially allocated according to the MPR of each BWP (alternatively, the data transmission of only the prioritized BWP may be performed). For example, the allocation of the transmit power may be determined based on a ratio between the number of available resource blocks (the number of resource blocks or the bandwidth of the BWP) and the number of resource blocks allocated using the DCI format. Here, a lower limit and an upper limit are configured for the maximum transmit power of the terminal apparatus, and the maximum transmit power within a specified range is configured according to capability of the PA. The MPR is used to determine the lower limit of the maximum transmit power. As the value of the MPR is increased, the lower limit of the maximum transmit power is reduced accordingly. With the reduced MPR, the maximum transmit power of the terminal apparatus including the PA of low performance can be configured to be higher. This enables data transmission of high transmit power, and high reliability can thus be satisfied.

Next, the following case is considered: DCI format 0_c is detected in the first BWP, DCI format 0_c is detected in the second BWP, and the modulation order included in DCI format 0_c of the first BWP is lower than the modulation order included in DCI format 0_c of the second BWP. In a case that the uplink grants of multiple DCI formats 0_c overlap in the time domain and total transmit power of the uplink data transmissions of the two BWPs exceeds the maximum transmit power of the terminal apparatus, the transmit power may be preferentially allocated to the first BWP whose modulation order to be used for the data transmission is lower (alternatively, the data transmission of only the prioritized BWP may be performed). Regarding this, in a case that the modulation order is low, the value of the MPR is low, and thus the maximum transmit power can be configured to be high according to capability of the PA included in the terminal apparatus. Here, a lower limit and an upper limit are configured for the maximum transmit power of the terminal apparatus, and the maximum transmit power within a specified range is configured according to capability of the PA. The MPR is used to determine the lower limit of the maximum transmit power. As the value of the MPR is increased, the lower limit of the maximum transmit power is reduced accordingly. With the reduced MPR, the maximum transmit power of the terminal apparatus including the PA of low performance can be configured to be higher. This enables data transmission of high transmit power, and high reliability can thus be satisfied.

The following case is considered: DCI format 0_c is detected in the first BWP, DCI format 0_c is detected in the second BWP, resource allocation in the frequency domain included in DCI format 0_c in the first BWP is close to a center area of the component carrier or the BWP, and resource allocation of the frequency domain included in DCI format 0_c of the second BWP is located at the end of the component carrier or the BWP. Here, regarding the resource allocation in the frequency domain, in a case that either the start position or the end position of the resource allocation is close to the end of the component carrier or the BWP, it may be determined that the resource allocation in the frequency domain is located at the end. In a case that the uplink grants of multiple DCI formats 0_c overlap in the time domain and total transmit power of the uplink data transmissions of the two BWPs exceeds the maximum transmit power of the terminal apparatus, the transmit power may be preferentially allocated to the first BWP whose resource to be used for the data transmission is located at the center of the component carrier or the BWP (alternatively, the data transmission of only the prioritized BWP may be performed). Regarding this, in a case that the resource to be used for the data transmission is located at the center of the component carrier or the BWP, the value of the A-MPR is low, and thus the maximum transmit power can be configured to be high according to capability of the PA included in the terminal apparatus. Here, a lower limit and an upper limit are configured for the maximum transmit power of the terminal apparatus, and the maximum transmit power within a specified range is configured according to capability of the PA. The A-MPR is used to determine the lower limit of the maximum transmit power. As the value of the A-MPR is increased, the lower limit of the maximum transmit power is reduced accordingly. With the reduced A-MPR, the maximum transmit power of the terminal apparatus including the PA of low performance can be configured to be higher. This enables data transmission of high transmit power, and high reliability can thus be satisfied.

Note that the present embodiment has given description of an example of the BWP. However, as the BWP, the component carrier (serving cell) may be used or the SUL may be used.

Note that the present embodiment has described a case that the dynamic scheduling is used for the detected uplink grants. However, the SPS/grant free access may be used for one of the detected uplink grants, and the dynamic scheduling may be used for the other of the detected uplink grants.

In the present embodiment, priority of the allocation of the transmit power in a case that the uplink grants are detected in multiple BWPs and the multiple uplink grants overlap in the time domain is determined. The base station apparatus determines the priority of the allocation of the transmit power, based on a configuration value of the uplink grants and the bandwidth of the BWPs. As a result, requirements of data that requires high reliability and low latency can be satisfied.

### Fourth Embodiment

The present embodiment will describe a determination method of priority of allocation of transmit power in a case that data transmission using the uplink grant and transmission of the uplink control information overlap in the time domain in multiple component carriers (serving cells) in a case that carrier aggregation is used. The communication system according to the present embodiment includes the base station apparatus 10 and the terminal apparatus 20 described with reference to FIG. 3, FIG. 4, FIG. 5, and FIG. 6. Differences from/additions to the first embodiment will be mainly described below.

The present embodiment will describe a case that the uplink grant of the SPS/grant free access or the dynamic scheduling is received by using DCI format 0_c, and the data transmission using the uplink grant of the first component carrier and the transmission timing of the uplink control information of the second component carrier overlap. In this case, the data transmission using the uplink grant requires high reliability and low latency. Conventionally, in a case of simultaneous timing with the data transmission, the transmit power is preferentially allocated to the uplink control information.

Here, in the present embodiment, the allocation method of the transmit power is determined depending on a type of the uplink control information to be transmitted at the same timing. First, in a case that DCI format 0_c is detected in the first component carrier, and transmission of the ACK/NACK as the uplink control information overlaps in the time domain in the second component carrier, the transmit power is preferentially allocated to the uplink control information, and the remaining transmit power is allocated to the data transmission of DCI format 0_c.

Next, in a case that DCI format 0_c is detected in the first component carrier, and transmission of the SR as the uplink control information overlaps in the time domain in the second component carrier, the transmit power may be preferentially allocated to the data transmission of DCI format 0_c, and the remaining transmit power may be allocated to the uplink control information, or transmission thereof may not be performed (may be dropped).

In a case that DCI format 0_c is detected in the first component carrier, and transmission of the CSI as the uplink control information overlaps in the time domain in the second component carrier, the transmit power may be preferentially allocated to the data transmission of DCI format 0_c, and the remaining transmit power may be allocated to the uplink control information, or transmission thereof may not be performed (may be dropped).

In a case that DCI format 0_c is detected in the first component carrier, and transmission of any of the ACK/NACK, the SR, and the CSI as the uplink control information overlaps in the time domain in the second component carrier, the transmit power may be preferentially allocated to the uplink control information, and the remaining transmit power may be allocated to the data transmission of DCI format 0_c, or transmission thereof may not be performed (may be dropped).

In a case that DCI format 0_c is detected in the first component carrier, and transmission of any of the SR and the CSI as the uplink control information overlaps in the time domain in the second component carrier, the transmit power may be preferentially allocated to the data transmission of DCI format 0_c, and the remaining transmit power may be allocated to the uplink control information, or transmission thereof may not be performed (may be dropped).

In a case that DCI format 0_c is detected in the first component carrier, and transmission of short uplink control information (short PUCCH) overlaps in the time domain in the second component carrier, the transmit power may be preferentially allocated to the uplink control information, and the remaining transmit power may be allocated to the data transmission of DCI format 0_c, or transmission thereof may not be performed (may be dropped).

In a case that DCI format 0_c is detected in the first component carrier, and transmission of long uplink control information (long PUCCH) overlaps in the time domain in the second component carrier, the transmit power may be preferentially allocated to the data transmission of DCI format 0_c, and the remaining transmit power may be allocated to the uplink control information, or transmission thereof may not be performed (may be dropped).

In the present embodiment, the priority of the allocation of the transmit power is determined based on an information type included in the uplink control information or a format of the PUCCH in a case that the data transmission using the uplink grant and transmission of the uplink control information overlap in the time domain in multiple component carriers (serving cells) in a case that carrier aggregation is used. As a result, requirements of data that requires high reliability and low latency can be satisfied.

Note that, regarding the embodiments of this specification, a combination of multiple embodiments may be applied, or only each individual embodiment may be applied.

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. Furthermore, the above-described program may be one for realizing some of the above-described functions, and also may be one capable of realizing the above-described functions in combination with a program already recorded in a computer system.

Furthermore, each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

The present invention can be preferably used in a base station apparatus, a terminal apparatus, and a communication method.

1. A terminal apparatus for communicating with a base station apparatus by using multiple component carriers, the terminal apparatus comprising:
a receiver configured to detect a first DCI format and a second DCI format; and
a transmitter configured to perform first data transmission in which data is transmitted by using allocation information of a radio resource included in the first DCI format and second data transmission in which data is transmitted by using allocation information of a radio resource included in the second DCI format, wherein
a number of bits of an MCS field included in the first DCI format is smaller than a number of bits of an MCS field included in the second DCI format,
the receiver detects the first DCI format for the first data transmission in a first component carrier, and detects the second DCI format for the uplink second data transmission in a second component carrier,
in a case that the first data transmission and the second data transmission overlap in a time domain, the transmitter allocates transmit power of the first data transmission and the second data transmission such that a sum of the transmit power of the first data transmission and the transmit power of the second data transmission does not exceed maximum transmit power, and
the transmit power of the second data transmission is configured not to exceed a value obtained by subtracting the first data transmission from the maximum transmit power.

2. The terminal apparatus according to claim 1, wherein
the receiver detects RRC information including information of a period of the radio resource,
the first data transmission allows data to be transmitted after activation of the radio resource periodic according to the period of the radio resource included in the RRC information and the first DCI format, and
the second data transmission allows data to be transmitted according to allocation of an aperiodic radio resource included in a DCI format.

3. The terminal apparatus according to claim 1, wherein
the receiver detects RRC information including information of a threshold of the transmit power of the second data transmission, and
in a case that the first data transmission and the second data transmission overlap in the time domain, and the sum of the transmit power of the first data transmission and the transmit power of the second data transmission exceeds the maximum transmit power, the transmitter allocates the transmit power to the first data transmission not to exceed the maximum transmit power, and only in a case that a difference between the maximum transmit power and the transmit power of the first data transmission exceeds the threshold of the transmit power, the transmitter performs the second data transmission.

4. The terminal apparatus according to claim 1, wherein
the first component carrier is a secondary cell, and the second component carrier is a primary cell or a primary secondary cell, or belongs to an MCG.

5. The terminal apparatus according to claim 1, wherein
the transmitter is capable of transmission of uplink control information, and
in a case that data transmission using the allocation information of the radio resource included in the first DCI format in the first component carrier and the transmission of the uplink control information in the second component carrier overlap in the time domain, the data transmission is prioritized in a case that the uplink control information is any one or both of an SR and CSI, and the data transmission and the uplink control information transmission are performed in a case that an ACK/NACK is included in the uplink control information and uplink data and the uplink control information can be transmitted simultaneously.
